(19) United States
(12) Patent Application Publication
(10) Pub. No.: US 2024/0192118 A1
(43) Pub. Date: Jun. 13, 2024

(54) DETECTION AND ANALYSIS OF PARTICLES SUSPENDED IN FLUID STREAMS

(71) Applicant: Regents of the University of Minnesota, Minneapolis, MN (US)

(72) Inventors: Yan Ye, Saratoga, CA (US); David Y.H. Pui, Medina, MN (US)

(21) Appl. No.: 18/505,745

(22) Filed: Nov. 9, 2023

Related U.S. Application Data
(60) Provisional application No. 63/431,240, filed on Dec. 8, 2022.
(60) Provisional application No. 63/509,623, filed on Jun. 22, 2023.

(51) Int. Cl. G01N 15/14; G06V 10/60; G06V 10/75; G06V 20/52; G06V 20/69

(52) U.S. Cl. CPC G01N 15/1475; G01N 15/1434; G06V 10/60; G06V 10/751; G06V 20/52; G06V 20/69; G01N 2015/144

(57) ABSTRACT

A system includes an inlet arm including a sampling inlet and an outlet arm including a sampling outlet. A particle sensor disposed between the sampling inlet and the sampling outlet includes at least one light source of a certain wavelength configured to irradiate at least one particle within a stream of fluid flowing from the sampling inlet to the sampling outlet with a focused or collimated beam of light. The particle sensor includes at least one image sensor or camera configured to capture image data relating to the at least one particle. The particle sensor also includes at least one light diffuser or reflector configured to form at least one monitoring image in the image data captured by the image sensor or camera relating to the at least one particle, wherein the monitoring image is configured to indicate an inlet condition of the sampling inlet or inlet arm.

This application claims the benefit of U.S. Provisional Patent Application No. 63/509,623, filed 22 Jun. 2023 and U.S. Provisional Patent Application No. 63/431,240, filed 8 Dec. 2022, the entire content of each application is incorporated herein by reference.

### BACKGROUND

Detection of suspended particles, such as airborne particles, may be important due to the impact of suspended particles on a range of issues, for example air pollution. Suspended particles may cause different adverse effects due to their relatively high specific surface area. Airborne nanoparticles can easily spread over a large area for extended periods and can easily enter and transfer within organisms and interact with cells and subcellular components. Detection of suspended particles may be an important step in treating fluids, such as exhaust from an engine, which may contain suspended particles. Detection and analysis of suspended particles may assist in evaluating systems or equipment designed to remove suspended particles.

### SUMMARY

In general, the disclosure is directed to systems and techniques for detecting and analyzing particles suspended within a stream of fluid, such as air. As described in more detail, the disclosed systems and techniques may use image processing to detect, analyze, quantify, and/or categorize suspended particles in air or another fluid. Furthermore, the disclosed detection and image processing techniques may be suitable to detect particles sized below about 100 nanometers, such as below about 50 nanometers, which may be beyond the capability of other particle detection techniques. The disclosed systems and techniques may reduce undercounting or overcounting particles in the stream of fluid. Furthermore, the disclosed systems and techniques may be configured to naturally draw a stream of air from an inlet to an outlet without using a pump, thus enabling omission of a pump and providing for

In one or more examples, a system includes an inlet arm with a sampling inlet, and an outlet arm with a sampling outlet, where a stream of fluid is configured to flow from the sampling inlet to the sampling outlet. In some examples, the stream of fluid may flow from the sampling inlet to the sampling outlet through a pressure difference naturally formed with a proper arrangement, for example by locating the sampling inlet near a central portion of a sampled pipe and a sampling outlet near a wall portion of the sampled pipe. In accordance with examples described in this disclosure, a particle sensor may be configured to detect particles within the stream of fluid flowing from the sampling inlet to the sampling outlet. The disclosed particle detection and analysis system may be configured to be mounted to a pipe (e.g., an engine exhaust pipe) and sample a stream of fluid from within the pipe to determine characteristics of one or more particles within the stream of fluid.

The disclosed systems may be portable relative to other particle analysis systems. In some examples, the disclosed systems may flow the stream of fluid through the particle detection system without using an additional device (pump) and power, which may allow for a reduced device footprint. Moreover, in some examples, the disclosed particle detection and analysis systems and techniques may allow for “smart” particle detection in that the system may be configured to determine inlet and outlet conditions, and/or the condition of the image sensor and light source. In some examples, the disclosed systems may flag whether the detected stream of fluid is representative of fluid in the sampled pipe (e.g., determine whether a sample inlet is plugged or clogged). Furthermore, the disclosed systems and techniques may allow for determining the condition of an image sensor and/or light source as indicated by the brightness or shape of a monitoring image formed from reflected or diffused light.

In addition to other physical and/or chemical parameters of the sampled stream of fluid, the disclosed systems and techniques may be used to categorize target particle types, such as soot particles or other particles of interest within the stream of fluid. The disclosed system may be configured to detect images generated by elastic scattered light and the induced fluorescence from the particles. The system may include processing circuitry configured to store image data from one or more image sensors in a detection video. The captured images of induced fluorescence in the detection video may be converted to quantitative information about one or more particles. The quantitative data may include one or more of a particle count, particle concentration, image size distribution, or wavelength distribution of induced fluorescence.

In some examples, the disclosure is directed to system which includes an inlet arm including a sampling inlet and outlet arm including a sampling outlet. A stream of fluid is configured to flow from the sampling inlet to the sampling outlet. A particle sensor is disposed between the sampling inlet and the sampling outlet, and the particle sensor includes at least one light source of a certain wavelength configured to irradiate at least one particle within the stream of fluid with a focused beam of light. The particle sensor further includes at least one image sensor or camera configured to capture image data relating to the at least one particle. The particle sensor also includes a light diffuser configured to transform the focused or collimated beam of light from the light source into an expanded beam, wherein the expanded beam is configured to project to the particle image sensor to indicate an inlet condition.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic view illustrating an example suspended particle detection system according to the present disclosure.

FIG. 2 is a block diagram illustrating of an example computing device according to the present disclosure.

FIG. 3 is a flowchart illustrating an example particle detection and analysis technique in accordance with one or more aspects of the present disclosure.

FIG. 4 is a flowchart illustrating an example particle detection and analysis technique in accordance with one or more aspects of the present disclosure.

FIG. 5 is a flowchart illustrating an example real-time particle detection and analysis technique in accordance with one or more aspects of the present disclosure.

FIG. 6 is a flowchart illustrating an example technique for converting sensed image data to quantitative and/or qualitative information about at least one particle.

FIG. 7A is a schematic illustration of an example image captured by an image sensor or camera according to the present disclosure.

FIGS. 7B-7D are schematic illustrations of the reflector of FIG. 7A in various operating conditions.

FIGS. 8A, 8B, 8C, and 8D are schematic illustrations of various representations of example particle.

FIG. 9 is a set of pictures illustrating the results of particle detection and image processing techniques in accordance with one or more aspects of the present disclosure.

FIG. 10 illustrates example reactions from a particle under irradiation by a light source.

FIG. 11 illustrates an example chromaticity diagram for determining a color hue used to calculate a dominant wavelength in accordance with one or more aspects of the present disclosure.

FIG. 12 illustrates an example color image in accordance with one or more aspects of the present disclosure.

FIG. 13 is a schematic diagram illustrating a portion of an example system in accordance with one or more aspects of the present disclosure.

FIG. 14 illustrates an example screenshot from a display according to the present disclosure.

FIG. 15 illustrates example results from particle recognition tests using techniques according to the present disclosure.

FIG. 16 illustrates example screenshots from an example display according to the present disclosure.

FIG. 17 illustrates example screenshots from an example display according to the present disclosure.

FIG. 18 illustrates a conceptual plot of an engine operating for a period of time.

FIG. 19 illustrates an example image captured by an image sensor according to the present disclosure.

### DETAILED DESCRIPTION

Detecting particles suspended in the air using optical detection techniques may be challenging compared to detecting particles suspended in liquids such as in water. This is because when particles move randomly in Brownian motion (motion caused by diffusion only), the diffusivity of suspended particles can be deduced from the autocorrelation function describing the fluctuation signals. For particles suspended in a liquid, it may be casy to maintain the motion of particles as Brownian motion, especially when the liquid is confined in a small container or in a stationary droplet. For particles suspended in the air, detection is still challenging. It may not be practical in some instances to confine air samples in small spaces or small containers or to control the motion of the airborne particles so that the motion is caused only by their diffusion. Since airborne nanoparticles are more mobile and more prone to uncontrolled non-Brownian motion than nanoparticles suspended in liquids, techniques that can successfully detect nanoparticles in liquids, such as DLS or advanced optic microscopes, are rarely used for detecting or analyzing airborne nanoparticles. Furthermore, advanced optic microscopes and similar techniques may not be suitable for detecting and analyzing air fluid streams of interest, such as those attached to engines, such as a diesel engine.

Systems and techniques according to the present disclosure may be suitable for particle detection of particles suspended in air or another fluid. For instance, techniques described in this disclosure may successfully detect and analyze airborne nanoparticles in a stream of air flowing through a sampled pipe or channel, such as an engine exhaust pipe, or in an open environment. Particles may be irradiated with a light source in a detection chamber, and an imager (e.g., a color image sensor or camera) may capture image data indicative of the detection chamber at a particular point in time. The image data may be image processed (e.g., in real-time or at a later time) to capture quantitative data and/or qualitative data about at least one particle within the detection chamber. For example, quantitative data may include one or more of a particle count, particle concentration, or particle size.

Furthermore, the disclosed particle detection systems and techniques may include one or more additional capabilities, which may, for example, improve reliability of the particle detection system. In some examples, particle detection and analysis systems according to the present disclosure may include a self-check feature. For example, a “monitoring image,” which may be included as part of a captured image of a detection chamber, may illustrate the condition of an inlet of the detection chamber as reflected or diffused light on a reflector. In some examples, processing circuitry of the particle detection system may create a data record of luminance values of the monitoring image. Thus, the condition of the inlet may be illustrated. If the luminance values of a threshold number of pixels of the monitoring image fall below a threshold, the image may be flagged as not representative of the true conditions of the sampled pipe due to a clogged or plugged inlet. If the sample inlet becomes partially or completely blocked, the disclosed system may allow a user to recognize the blockage on the monitoring image, or create a data record indicating that the monitoring image does not meet a threshold for inclusion as part of a data set that is analyzed by the system. In this way, under or over estimation of particle counts in the sampled pipe due to improper sampling may be reduced or eliminated. Since under or overestimation of particle count may result in environmental and/or health problems, or cause unnecessary engine maintenance, or improper reactions by users, the disclosed systems and techniques may include one or more improvements over particle detection systems which do not include a feature which allows for monitoring of sampling conditions as well as particle detection.

Such a feature may render the system “smart” as image data may be checked against one or more second sets of data, which may or may not be captured by the particle detection system. For example, the second set of data may include the sampling inlet or outlet condition, as described above. Additionally, or alternatively, the second sets of data may include an engine operation condition, laser or image sensor conditions, combinations thereof, or the like. In some examples, an alarm or other warning system may indicate a situation in which the image data does not satisfy a threshold. In some examples, image data captured by an image sensor when the image data does not satisfy a threshold may be flagged. Flagging, as described herein, may mean that a data record is created indicating that the image data does not satisfy a threshold. In some examples, the flagged image data may be discarded.

The disclosed systems and techniques may include relatively lightweight, small, and/or portable devices relative to other particle detection equipment, allowing for mounting the disclosed systems in places otherwise unavailable for particle detection and analysis (e.g., in or near an engine compartment of a vehicle). The disclosed systems may include a detection chamber, which may provide a relatively more reliable and controlled sampling environment, and may be suitable for integration with other sensors to support synchronized sampling and measurement (e.g., NOₓ count or concentration, COₓ count or concentration, temperature, fluid flow rate, or the like). Additionally, the disclosed systems and techniques may include pumpless sampling, where a flow is naturally formed between a sampling inlet and a sampling outlet. In this way, a pump, fan, or other device configured to flow the fluid from the sampling inlet to the sampling outlet may be omitted. In this way, the disclosed systems and techniques may be more compact, lighter, more power efficient, and/or more reliable since fewer components which can fail are included.

Furthermore, the disclosed systems and techniques may be used to detect specific particle species or particle types suspended in a fluid. For example, certain particles within a fluid may be of particular interest. Such particles may be detected by the disclosed systems and techniques because irradiation of suspended particles with light of a certain known wavelength may induce fluorescence in some types of particles and not induce fluorescence in other types of particles. For example, excitation of some wavelengths of light may induce fluorescence in certain known particle types or species, and not induce fluorescence in other particles.

The disclosed system may include a light source configured to emit light at wavelengths which induce fluorescence in some particles and not induce fluorescence in other particles. The imager may be configured to detect the induced fluorescence by filtering at least a portion of the sensed image data so that only induced fluorescence is detected. In some examples, a single imager may be used, and a portion of the image data may be filtered such that a portion of the captured image data may be filtered to capture the induced fluorescence of at least one particle. Alternatively, in some examples, a second imager may be included, and one imager may be configured to capture elastic scattered light scattered by the particle, where particles scatter light according to their size as demonstrated by the principles of Rayleigh scattering. As such, the second imager may include a filter configured to capture only induced fluorescence of the particle or particles in the detection chamber. The dominant color hue of the induced fluorescence may be used to calculate a dominant wavelength of the particle. Since the wavelength (e.g., the dominant wavelength) of certain particles is known, this wavelength may be used in categorize the detected particle or particles into different categories. The emitted wavelength of a particle in the detection chamber may be compared to a database of known particles in a database, and a match may allow for a particular particle species to be recognized.

Moreover, the disclosed systems and techniques may employ a particle light scattering image detection technique for detection and classification of particles smaller than as 0.1 micrometers in a greatest cross-sectional dimension, such as smaller than 0.05 micrometers in a greatest cross-sectional dimension. Thus, the described systems and techniques may be configured to detect, identify, count, and/or classify, and output for display in graphical form a representation of particle image data in substantially real-time (e.g., real-time or nearly real-time), even when the sampled particles are smaller than the limits of other particle detection and analysis systems.

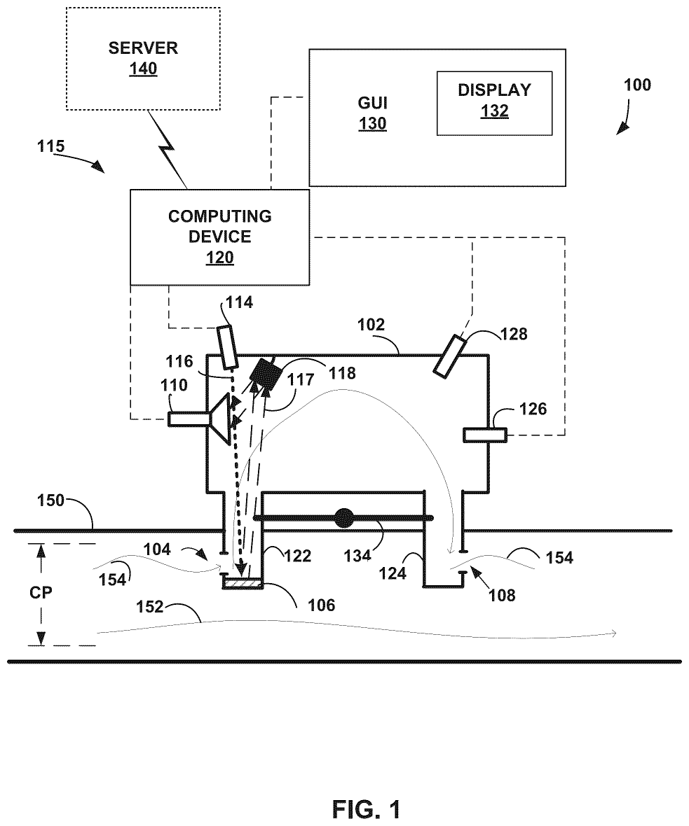

FIG. 1 is a schematic perspective view of example system 100 for detecting and image processing suspended particles according to one or more aspects of this disclosure. System 100 includes detection chamber 102, imager 110, light source 114, light diffuser 106, differential pressure sensor 132, physical sensor(s) 126, chemical sensor(s) 128, and workstation 115. Workstation 115 includes computing device 120, graphical user interface (GUI) 130, and server 140. System 100 may be an example of a system for use in a particle detection laboratory, or may be a portable system configured to be deployed outside a laboratory setting, such as mounted on or within a moving vehicle.

In the illustrated example, system 100 is mounted on sampled pipe 150, through which flows stream of fluid 152. In some examples, sampled pipe 150 may be a tailpipe of a diesel or gas-powered vehicle such as a car, a truck, or an aircraft. As such stream of fluid 152 may include particles for detection and analysis to determine engine characteristics and/or determine emissions according to regulation, or the like.

Detection chamber 102 may be a chamber configured to receive stream of fluid 154 (e.g., air) containing suspended particles for excitation and/or irradiation by light source 114 and image detection by imager 110 before outputting the stream of fluid through one or more outlets 108. In some examples, as illustrated, it may be desirable to collect stream of fluid 154 from a central portion CP of sampled pipe 150, to ensure stream of fluid 154 is representative of stream of fluid 152. Central portion CP is a portion of sampled pipe 150 that has boundaries displaced from the walls of sampled pipe 150. In some examples, central portion CP may include 25% of the diameter of sampled pipe 150 on each side of a central longitudinal axis of sampled pipe 150 (i.e., CP may include the center 50% of sampled pipe 150). As such, system 100 may include inlet arm 122 extending from detection chamber 102 into sampled pipe 150. Inlet 104 may be disposed on inlet arm 122. In some examples, inlet 104 may be positioned to face upstream, such that stream of fluid 154 may flow naturally through detection chamber 102 without the input of additional energy (e.g., pumpless sampling).

Similarly, outlet arm 124 may extend from detection chamber 102 through an aperture in sampled pipe 150. Outlet arm 124 includes one or more outlets 108 configured to flow stream of fluid 154 back into sampled pipe 150 after particle detection and analysis is performed on fluid stream 154 by system 100. In some examples, outlet 108 may face downstream, such that stream of fluid 154 may flow through system 100 naturally based on the flow through sampled pipe 150, without the need for a pump or other equipment designed to input energy into stream of fluid 154. In some examples, as illustrated outlet arm 124 may extend into central portion CP of sampled pipe 150. However, alternatively, in some examples, outlet arm 124 may extend such that outlet 108 is disposed near wall 150 (e.g., outside central portion CP). In some examples, disposing inlet 104 within central portion CP and outlet 108 outside of central portion CP may increase a pressure differential from inlet 104 to outlet 108, such that stream of fluid 154 flows naturally through system 100 without energy input from a pump or similar device.

Pressure differential sensor 134 may be configured to monitor a pressure drop between inlet 104 and outlet 108. In some examples, system 100 may not include inlet arm 122 and/or outlet arm 124. In such examples, inlet 104 and/or outlet 108 may be defined by detection chamber 102 directly. In these examples, associated piping or tubing may route stream of fluid 154 to detection chamber 102, or detection chamber 102 may be placed directly in stream of fluid 152, which may in some examples be open to the atmosphere.

Light source 114 may be configured to emit focused beam of light 116 into detection chamber 102, and imager 110 may be configured to capture image data within detection chamber 102. In some examples, detection chamber 102 may be configured to control light within detection chamber 102, such as by allowing light source 114 to irradiate particles and blocking out other light. Therefore, detection chamber 102 may include walls or a lining which create a dark background by completely or nearly completely occluding ambient light from outside detection chamber 102, for example by reducing or eliminating cracks for light to enter detection chamber 102.

Workstation 115 may include, for example, an off-the-shelf device, such as a laptop computer, desktop computer, tablet computer, smart phone, or other similar device. In some examples, workstation 115 may be a specific purpose device. Workstation 115 may be configured to control pump 108 and/or any associated valves, imager 110, light source 114, or any other accessories and peripheral devices relating to, or forming part of, system 100.

Computing device 120 may include, for example, an off-the-shelf device such as a laptop computer, desktop computer, tablet computer, smart phone, or other similar device or may include a specific purpose device. In some examples, computing device 120 may control imager 110, light source 114, physical sensor(s) 128, chemical sensor(s) 126, or any other accessories and peripheral devices relating to, or forming part of, system 100 and may interact extensively with workstation 115. Workstation 115 may be communicatively coupled to computing device 120, enabling workstation 115 to control the operation of imager 110 and receive the output of imager 110.

Graphical user interface (GUI) 130 may be configured to output instructions, images, and messages relating to at least one of a performance, position, viewing angle, image data, or the like from imager 110, light source 114, physical sensor 126, and/or chemical sensors 128. Workstation 115 may be configured to integrate with another system, such as an engine associated with sampled pipe 150. In such examples, GUI 130 may be configured to output performance or operational data from the associated system as well as system 100. For example, GUI 130 may be configured to output one or more of an engine mode, speed, or the like. GUI may include display 132. Display 132 may be configured to display outputs from any of the components of system 100, such as computing device 120. Further, GUI 130 may be configured to output information regarding imager 110, e.g., model number, type, size, etc. on display 132. Further, GUI 130 may be configured to output sample information regarding sampling time, location, volume, flow rate, or the like. GUI 130 may be configured to present options to a user that include step-by step, on screen instructions for one or more operations of system 100. For example, GUI 130 may present an option to a user to select a file of sensed image data from imager 110 at a particular point in time or a duration in time as video image data. GUI 130 may allow a user to click rather than type to select, for examples, an image data file from imager 110 for analysis, a technique selection for system 100, a mode of operation of system 100 or an associated system, various settings of operation of system 100 (e.g., an intensity or wavelength of light from light source 114, a zoom, angle, or frame rate of imager 110, or the like) or various settings of operation of an associated system (e.g., an engine associated with sampled pipe 150), a plot other presentation of quantitative information relating at least one particle in detection chamber 102, or the like. As such, GUI 130 may offer a user zoom in and zoom out functions, individual particle images with size and/or wavelength distribution, imager sensor setup and preview in a large pop-up, on-board sensor and analysis control, pause and continue functions, restart and reselect functions, or the like.

Light source 114 is configured to generate focused beam 116 of light into detection chamber 102 to irradiate at least one particle within detection chamber 102 at a certain wavelength or wavelengths. In some examples, focused beam 116 may be collimated and/or focused by a lens system, and configured to beam across detection chamber 102 to a light trap.

Alternatively, as illustrated, system 100 may have a self-check system, wherein beam 116 is directed to light diffuser 106. Light diffuser 106 may be positioned in inlet arm 122 as illustrated to monitor inlet 104. Additionally, or alternatively, light diffuser 106 may be positioned in outlet arm 124 and be configured to monitor outlet 108. In some examples, two or more light sources 114 may be included, and two or more light diffusers 106 may be employed to monitor both inlet 104 and outlet 108.

In some examples, focused beam 116 may be generated at the certain target wavelength. Alternatively, in some examples, light at a variety of wavelengths may be generated by light source 114, and light source 114 may include one or more filters, such as short-pass or long-pass filters configured to occlude light at certain wavelengths and prevent the occluded wavelengths from being beamed into detection chamber 102. Light source 114 may include a laser, LED, or another light generating device. Light source 114 may generate and/or employ a filter system such that focused beam 116 includes wavelengths less than 450 nanometers (nm), for example from about 250 nm to about 450 nm, or from about 250 nm to about 350 nm. Light at these wavelengths may induce fluorescence in target particles while not inducing, or only minimally inducing, fluorescence in other types of particles. Light source 114 may be external, that is, located remotely from imager 110. In some examples, system 100 may include multiple light sources, which may use the same or different light generating techniques, and may generate one or more than one focused beam 116 at the same wavelength(s) or different wavelength(s).

Light source 114 may include a lens system configured to generate focused beam 116 as a collimated beam. A collimated beam may have light rays that are substantially parallel. In this way, beam 116 may focus on a particular region within detection chamber 102, such as a portion of detection chamber 102 where the fluid stream containing suspended particles are configured to pass. In some examples, light source 114 may irradiate stream of fluid 152 as stream of fluid 152 passes through detection chamber 102 in front of imager 110.

Light diffuser 106 is configured to transform focused beam 116 to expanded beam 117. For example, light diffuser 106 is configured to reflect and spread focused beam 116 generated by light source 114 as expanded beam 117. As such, light diffuser 106 may include a number of reflective surfaces configured to spread focused beam 116. For example, focused beam 116 may travel through detection chamber 102 with a first cross-sectional area. Expanded beam 117 may travel through detection chamber 102 with a second cross-sectional area. In some examples, the second cross-sectional area may be larger than the second cross-sectional area. In some examples, light diffuser 106 may be configured to generate expanded beam 117 with the same cross-sectional area as inlet arm 122. In this way, expanded beam 117 may be configured to pass light waves from all or part of the cross-sectional area of inlet arm 122.

Detection chamber 102 may house reflector 118. Although illustrated as a single reflector 118, in some examples more than one reflector 118 may be used. Reflector 118 may be configured to reflect expanded beam 117 to imager 110. In some examples, reflector 118 may include a mirror mounted at an angle such that expanded beam 117 is directed to imager 110. An image of reflector 118 may be captured by imager 110, and the image of reflector 118 on the captured image may be called the “monitoring image,” as will be further described below.

Imager 110 is configured to capture image data indicative of at least one particle in a region of interest in detection chamber 102. For example, imager 110 may include a lens system which makes imager 110 focused on a region of detection chamber 102 within beam 116 of light source 114. Imager 110 may be a single image sensor or camera, as illustrated, which may be configured to capture image data as clastic light scattering data, induced fluorescence data, or both. In some examples, one or more filters (e.g., short pass filters) may be included which may reduce or eliminate light of certain selectable wavelengths from reaching an array of image sensors within imager 110 such that imager 110 captures only induced fluorescence from at least one particle suspended within detection chamber 102.

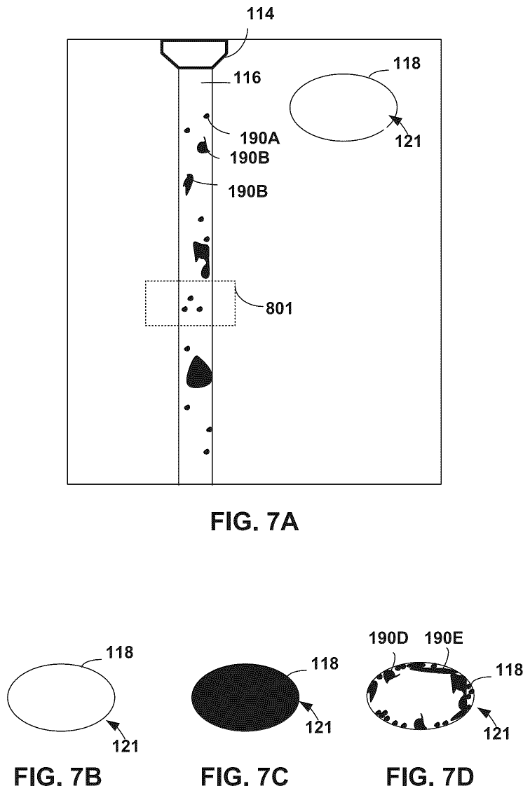

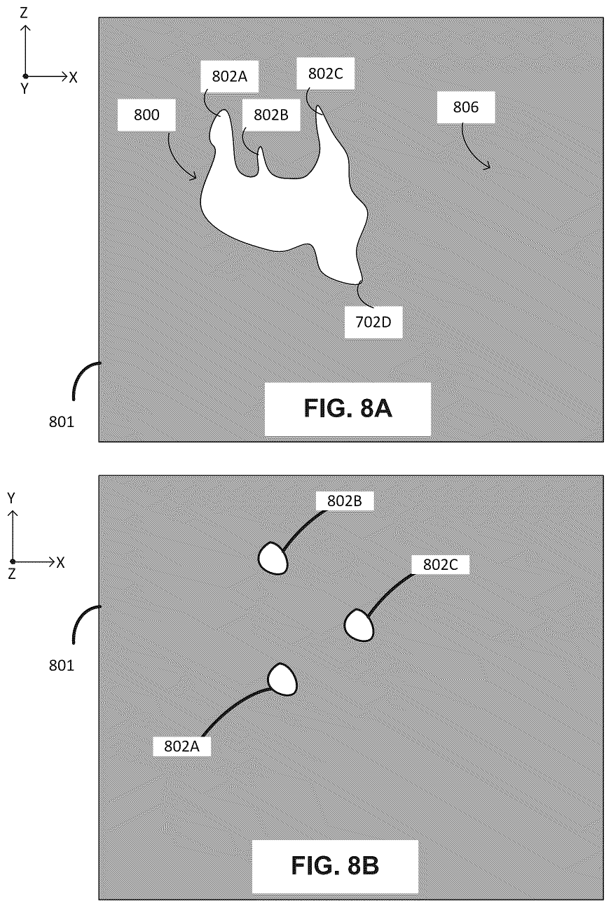

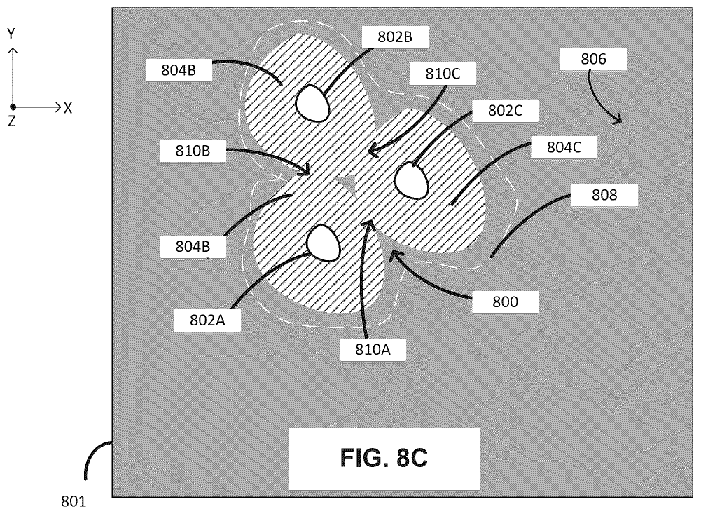

Furthermore, imager 110 may be configured to capture image data of reflector 118 as all or a portion of a captured image. The image data of reflector 118 (the “monitoring image’) captured by imager 110 may be indicative of a condition of inlet 104, inlet arm 122, or another condition of system 100, as will be further discussed below with respect to FIGS. 7A-7D.

In some examples, imager 110 may include more than one imager, such as a camera for sensing induced fluorescence (e.g., by filtering) and a camera for sensing elastic light scattering. Another imager 110 may be employed to capture image data indicative of an inlet condition, such as expanded beam 117. In some examples, imager 110 may be configured to capture image data as a picture or frame (i.e., image data sensed at a particular point in time) or as video data. In some examples, a frame may refer to an overall matrix of image data captured by imager 110. The overall matrix may be made up of individual pixels, or multiple matrices made up of individual pixels (e.g., three image data matrices including a red matrix, a green matrix, and a blue matrix). Video data, as used herein, comprises a series of frames over a duration in time. In some examples, the video data may be a series of frames over a duration in time, and each respective frame in the series of frames may be separated in time from the adjacent frames by the same length of time.

Similarly, in some examples, more than one light source 114 may be employed. For example, one light source may be configured to generate focused beam 116 to irradiate one or more particles in stream of fluid 154. In such examples, the focused beam may be directed to a light trap on a wall of detection chamber 102 configured to trap the focused beam and prevent reflection of the focused beam in detection chamber 102. A second, separate light source may generate expanded beam 117. In such examples, expanded beam 117 may be configured to reach imager 110 or a second imager.

Imager 110 may be a color image sensor or camera. Accordingly, imager 110 may include color sensors, which may be located in a sensor array. The color image sensor configured to detect colors in addition to black and white and capture the detected colors in one or more data matrices made up of individual pixels. Accordingly, in some examples, imager 110 may sense, capture, and record image data that includes red, green, and blue sensors, and may assign a value for red, green, and blue respectively for each pixel, creating a red matrix, a blue matrix, and a green matrix. Imager 110 or associated processing circuitry may also create an overall image data matrix. The overall image data matrix may be a sum of the red, green, and blue matrices for, and/or may be the average of the red, green, and blue matrices, or based on some other mathematical operations (e.g., weighted average, scaling, etc.). Imager 110 may be configured to sense, capture, store, and/or transmit image data in a data matrix as any or all of the red matrix, green matrix, blue matrix, or overall data matrix.

Each respective matrix may include a luminance value for each pixel in the data matrix. For example, the overall data matrix may include an overall luminance value for each pixel in the overall matrix, which may be based on scaling the values in red, green, and blue matrices. As one example, the overall image data matrix may include a luma for each individual pixel, which may be a weighted sum of gamma-compressed value from each of the red image data matrix, the green image data matrix, and the blue image data matrix. In some examples, the luminance value for each pixel may be based on conversion of the overall matrix to a grayscale image that includes luminance values. The techniques described in this disclosure should not be considered limit ways to determine luminance values.

In some examples, the each of the red, green, blue, and overall data matrices may include a rectangular array of pixels, such as a 1980×1080 data matrix. Processing circuitry within imager 110 or another component of system 100, such as computing device 120, may be configured to break up the overall data matrix (e.g., 1980×1080 pixels, or another matrix size) into a grid of smaller data matrices (e.g., 100×100 pixels, or another matrix size). A grid of smaller data matrices may be considered as a subset of pixels (e.g., 100×100 pixels is a subset of the 1980×1080 pixels). As described in more detail, sweeping processing across subset of pixels may allow for efficient utilization of processing capabilities, as compared to processing the overall data matrix, while ensuring that particles are properly identified in respective subsets. However, the example techniques are not so limited, and processing of the overall data matrix is also possible, as described below.

Computing device 120 may be communicatively coupled to imager 110, GUI 130, light source 114, physical sensor(s) 128, chemical sensor(s) 126, and/or server 140, for example, by wired, optical, or wireless communications. Server 140 may be a server which may or may not be located in a particle detection laboratory, a cloud-based server, or the like. Server 140 may be configured to store image data as video data, still frame data at a particular point in time, particle information, calibration information, or the like.

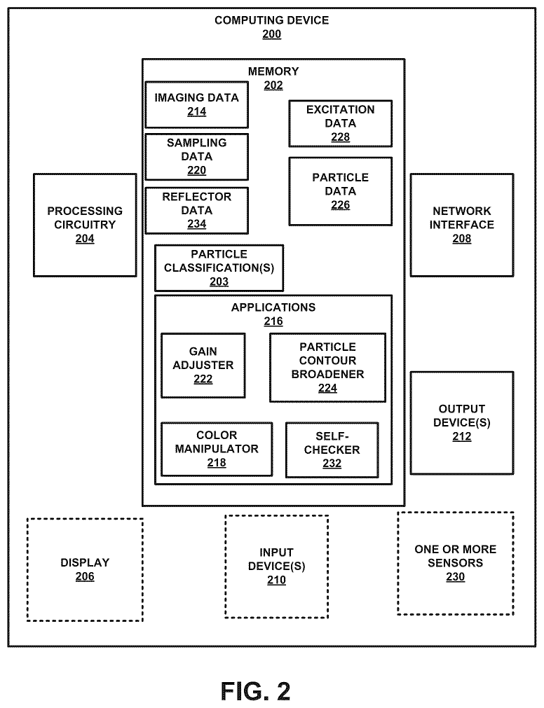

FIG. 2 is a block diagram of example computing device 200 in accordance with one or more aspects of this disclosure. Computing device 200 may be an example of computing device 120, workstation 115, and/or server 140 of FIG. 1 and may include a workstation, a desktop computer, a laptop computer, a server, a smart phone, a tablet, a dedicated computing device, or any other computing device capable of performing the techniques of this disclosure.

In some examples, computing device 200 may be configured to perform image processing, control and other functions associated with workstation 115, imager 110, light source 114, physical sensor(s) 128, chemical sensor(s) 126, or other function of system 100 of FIG. 1. As shown in FIG. 2, computing device 200 represents multiple instances of computing devices, each of which may be associated with one or more of workstation 115, imager 110, light source 114, or other elements. Computing device 200 may include, for example, a memory 202, processing circuitry 204, a display 206, a network interface 208, an input device(s) 210, or an output device(s) 212, each of which may represent any of multiple instances of such a device within the computing system, for ease of description.

While processing circuitry 204 appears in computing device 200 in FIG. 2, in some examples, features attributed to processing circuitry 204 may be performed by processing circuitry of any of computing device 120, workstation 115, imager 110, server 140, light source 114, or combinations thereof. In some examples, one or more processors associated with processing circuitry 204 in computing device 200 may be distributed and shared across any combination of computing device 120, workstation 115, imager 110, server 140, light source 114, or other elements of FIG. 1. Additionally, in some examples, processing operations or other operations performed by processing circuitry 204 may be performed by one or more processors residing remotely, such as one or more cloud servers or processors, each of which may be considered a part of computing device 200. Computing device 200 may be used to perform any of the techniques described in this disclosure, and may form all or part of devices or systems configured to perform such techniques, alone or in conjunction with other components, such as components of computing device 120, workstation 115, imager 110, server 140, or a system including any or all of such devices.

Memory 202 of computing device 200 includes any non-transitory computer-readable storage media for storing data or software that is executable by processing circuitry 204 and that controls the operation of computing device 120, workstation 115, imager 110, or server 140, as applicable. In one or more examples, memory 202 may include one or more solid-state storage devices such as flash memory chips. In one or more examples, memory 202 may include one or more mass storage devices connected to the processing circuitry 204 through a mass storage controller (not shown) and a communications bus (not shown).

Although the description of computer-readable media herein refers to a solid-state storage, it should be appreciated by those skilled in the art that computer-readable storage media may be any available media that may be accessed by the processing circuitry 204. That is, computer readable storage media includes non-transitory, volatile and non-volatile, removable and non-removable media implemented in any method or technology for storage of information such as computer-readable instructions, data structures, program modules, or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium that may be used to store the desired information and that may be accessed by computing device 200. In one or more examples, computer-readable storage media may be stored in the cloud or remote storage and accessed using any suitable technique or techniques through at least one of a wired or wireless connection.

Memory 202 may store one or more applications 216. Applications 216 may include a gain adjuster 222, a particle contour broadener 224, color manipulator 218, self-checker 232, and/or other computer vision model(s) or machine learning module(s), such as a model to determine particle contours in sensed image data, broaden particle contours to determine broadened particle contours, determine a particle boundary based on the broadened particle contours, or the like. Applications 216 stored in memory 202 may be configured to be executed by processing circuitry 204 to carry out operations on imaging data 214 of at least one particle within detection chamber 102 (FIG. 1). Although separate instructions for processing circuitry 204 are described as residing within certain applications 216, it should be understood that the described functionality assigned to, for example gain adjuster 222, may be assigned to different applications, for example, particle contour broadener 224, self-checker 232, color manipulator 218, or combinations of applications. In other words, instruction for processing circuitry are only described as residing within particular applications for ease of understanding.

One of applications 216 is self-checker 232. Self-checker 232 may be configured to determine whether an inlet condition of inlet 104 satisfies a threshold level of openness. For example, self-checker 232 may determine whether a threshold level portion of expanded beam 117 is visible on reflector 118 by imager 110, as will be further described below with respect to FIG. 7A-7D. Responsive to determining that the inlet condition does not satisfy a threshold level of openness, processing circuitry 204 may flag image data captured by imager 110. In some examples, to flag the image data, processing circuitry 204 may cause a data record to be stored in memory 202 that indicates that the inlet condition did not satisfy the threshold. In some examples, the flagged image data may be discarded. In some examples, the image data related to expanded beam 117 may be stored by memory 202 as reflector data 234. Processing circuitry 204 may, in some examples, register or time stamp reflector data 234 relative to other data stared in memory 202. Reflector data 234 may be called monitoring image data.

Furthermore, additionally or alternatively to flagging image data, processing circuitry 204 may be configured to output an alarm or other indicator or warning signal to indicate that system 100 (e.g., inlet 104 and/or inlet arm 122) should be cleaned. Additionally, or alternatively, processing circuitry 204 may be configured to recognize that no portion of expanded beam 117 is captured by imager 110, and output an indication that an error has occurred with light source 114 and/or imager 110. Processing circuitry 204 may be configured to execute self-checker 232 according to a number of modes. For example, self-checker 232 may be operated continuously, or intermittently, or only upon a start-up of system 100.

Memory 202 may store imaging data 214 and excitation data 228. Imaging data 214 may be captured by one or more sensors within or separate from imager 110 (FIG. 1) during a particle detection operation. Processing circuitry 204 may receive imaging data 214 from one or more image sensors within imager 110 and store imaging data 214 in memory 202, for example as a frame which includes the red matrix, green matrix, blue matrix, overall matrix, or combinations thereof. Sampling data 220 may be generated by imager 110, an engine associated with sampled pipe 150, or other components of FIG. 1. Processing circuitry 204 facilitates storage of sampling data 220. Excitation data 228 (e.g., wavelength(s), intensity, focus area, etc.) may be generated by light source 114, and processing circuitry 204 may facilitate storage of excitation data 228 within memory 202.

Processing circuitry 204 is configured to generate at least one of quantitative or qualitative information for the at least one particle within detection chamber 102. The quantitative data may include one or more of a particle count, particle size, and or a particle concentration, and/or how these or other quantitative data change over time (e.g., from frame to frame in a video file). Example qualitative data may include one or more of a particle category (e.g., soot particle generated by an engine or not a soot particle) or particle species (e.g., specific particle of interest), particle image of a particular particle, or the like. Qualitative data may be generated by comparing imaging data 214 to stored particle data 226 and particle classifications 203. Stored particle data 226 may include calibration data of known particle size, count, concentration, category, species or the like. Processing circuitry 204 may register imaging data 214 and/or excitation data 228 using timestamps (which may be placed in the data by, for example, imager 110, computing device 120, or workstation 115). Processing circuitry 204 may output for display by display 206, e.g., to GUI 130 of FIG. 1, imaging data 214 converted to quantitative and/or qualitative information about at least one particle by processing circuitry 204, for example by a plot or chart.

In some examples, processing circuitry 204 may perform an analysis technique on stored imaging data 214, which may be called analysis mode operation. Processing circuitry 204 may be configured to output for display on GUI 130 of FIG. 1 an option for a user to select an image file from imaging data 214. Processing circuitry 204 may be configured to determine whether the selected file is readable, and responsive to determining that the file is readable, read a frame from the file. Processing circuitry 204 may be configured to employ one or more applications 216 to analyze image data stored within the file to identify at least one particle in the frame and generate quantitative information and/or qualitative information about the at least one particle.

In some examples, processing circuitry 204 may perform a real-time particle detection and analysis technique. Processing circuitry 204 may receive image data directly from imager 110, or from imaging data 214 stored in memory 202, and, in substantially real time, capture a first frame of the sensed image data representing data sensed at a first time. Substantially real-time, as used herein, may mean that the image data is captured and analyzed without stopping the imager 110, that is, during the sampling operation. Processing circuitry 204 is configured to analyze image data in the frame to identify at least one particle, convert image data within the frame to quantitative information about the at least one particle within the frame at the first time, and capture a second frame of the sensed image data representing data sensed at a second time.

Processing circuitry 204 may be configured to execute color manipulator 218 to generate grayscale image data from color image data sensed by imager 110. Alternatively, processing circuitry 204 may facilitate receipt of grayscale image data. Regardless, grayscale image data may be obtained by processing circuitry 204 for analysis. The grayscale image data may be the overall image data matrix, which may be created by scaling of each of the red, green, and blue matrices. The resulting grayscale image data may include a luminance value for each pixel in an image data matrix, as described above.

Processing circuitry 204 may be configured to determine particle contours of at least one particle in detection chamber 102 in the sensed the image data based on the luminance values of the grayscale image, or of other image data. For example, the luminance value of a particular pixel may be relatively high, indicating the presence of an irradiated particle in the location of the pixel in the grayscale image. Particle contours, as described herein, may be a particle boundary, but due to the small size and irregular shape of some particles, particle contours may in some examples only represent a feature (e.g., a spike) on a particle. In some examples, particle contours may be lights spots (e.g., pixels with relatively higher luminance values) that satisfy a threshold. One example of the threshold is an average of a subset of pixels, and pixels within that subset that are greater than the threshold are part of the particle contours.

That is, processing circuitry 204 may determine that, when a particular pixel satisfies a threshold, the pixel is part of the particle contours of a particle. Adjacent pixels that all satisfy the threshold may be grouped together as a group of pixels that form an island (or a “spot”) of particle contours. In some examples, processing circuitry 204 may be configured to identify pixels having luminance values that satisfy the threshold by determining local thresholds within respective subsets of pixels (e.g., each respective small matrix in a grid of small matrices making up the overall matrix). Processing circuitry 204 may be configured to compare luminance values of pixels within each respective subsets of pixels to respective local threshold for that subset of pixels. Then, processing circuitry 204 may be configured to sweep through the subsets to pixels to identify the pixels based on the comparison, and determine particle contours by grouping the identified pixels of each of the respective subsets of pixels together as an island of particle contours. In other words, in some examples, the threshold may be assigned as the average value of a small matrix (e.g., a subset of the overall number of pixels, such as a 100×100 matrix of pixels) in which the particular pixel resides, and each individual pixel above the average of the small matrix in which it resides may be assigned as belonging to an island of particle contours.

In some examples, the threshold may be assigned as the average luminance value of the entire image data matrix (e.g., a 1980×1080 matrix of pixels) and each individual pixel with a luminance value above the average may be assigned as part of a group of proximate pixels an island of particle contours. In some examples, the threshold may be set by a fitting function. In some examples, the fitting function may use both the small matrix in which the particle resides and the overall matrix to determine whether an individual pixel is part of the particle contours. In some examples, processing circuitry 204 may execute a fitting function to identify particular pixels within the small matrix as being part an of island of particle contours. In some examples, the fitting function may be a Gaussian function, an adaptive mean threshold, an adaptive Gaussian function, combinations thereof, or another fitting function.

In some examples, processing circuitry 204 may be configured to determine particle contours in other ways. For example, processing circuitry may scan the grayscale image to find a local peak. The local peak may be found when processing circuitry 204 determines that a difference value indicative of a difference between luminance values of proximate pixels satisfies a threshold; and based on the difference value satisfying the threshold, determines that one of the pixels (e.g., the pixel with the higher luminance value) is part of the particle contours for the at least one particle. In some examples, processing circuitry may scan surrounding pixels for other local peaks. In some examples, processing circuitry 204 may determine that all local peaks within a certain number of pixels from each other are part of the same island of particle contours. For example, where a local peak is found within 1, 2, 3, 4, 5, or other number of pixels of another local peak, processing circuitry 204 may connect the local peaks as part of the same particle contours.

In some examples, before executing the algorithm or function configured to determine particle contours, processing circuitry 204 may be configured to reduce or eliminate macroscale differences in luminance values due to imager 110, light source 114, and/or detection chambers by executing gain adjuster 222. In some examples, gain adjuster 222 may adjust (e.g., change) the average luminance value of each individual pixel within a small matrix within the grid of small matrices. In this way, the overall image data matrix may be normalized to account for trends in average luminance values on a macro level, such that each grid may have the same or a similar average luminance value relative to the rest of the small matrices within the grid.

It may be possible that counting each island of particle contours may result in overcounting and/or under-sizing particles, because two or more spikes or other topographical features on the same particle may show up as individual islands of particle contours in the luminance values of the image data. That is, two individual islands may be for the same particle, but appear to be for different particles, and therefore, two particles are counted for one particle. Processing circuitry 204 may be configured to execute one or more applications configured to address such possible overcounting. For example, processing circuitry 204 may determine a particle boundary based on the determined particle contours broadening the determined particle contours and may determine a particle boundary based on the broadened particle contours. For example, applications 216 may include particle contour broadener 224, which may store instructions for processing circuitry to execute such an operation.

Processing circuitry 204 may execute the particle contour broadener 224 application, which may be housed within memory 202 of computing device 204. Particle contour broadener 224 may be configured to adjust (e.g., change by increasing or decreasing) the luminance value for individual pixels within the overall image data matrix (e.g., 1980×1080 pixels). Particle contour broadener 224 may be configured to adjust (e.g., increase or decrease) the luminance values of the image data to assist in determining a particle boundary from sensed particle contours. For example, particle contour broadener 224 may be configured to group several small islands of particle contours together to define a particle boundary that includes each of the more than one islands of particle contours as one particle by defining a boundary around both of the islands. For example, particle contour broadener 224 may be configured to broaden the particle contours by assigning additional pixel points around an identified spot or island the same luminance value as a neighboring pixel, such that particle contour broadener 224 may connect small spots very close to each other as a big spot to avoid over-counting one big particle as many small particles.

In some examples, processing circuitry 204 may determine broadened particle contours by determining that the identified pixels include a first pixel and a second pixel that are separated by a distance. Processing circuitry 204 may be configured to assign one or more pixels, within the distance, proximate to the first pixel and second pixel approximately the same luminance value as nearest pixel within identified pixels to create a broadened cluster of pixels that include the first pixel and the second pixel; and determine the particle contours based on the cluster of pixels.

Accordingly, particle contour broadener 224 may reduce overcounting and/or under-sizing of particles, because particles with topography that is sensed and stored as image data that includes separate islands of particle contours connects the small spots together as one larger spot, and correctly counts and sizes the multiple spots as a single particle. In some examples, particle contour broadener 224 may be configured to broaden the sensed particle contours by increasing the luminance values of one or more pixels proximate to the sensed particle contours to define broadened particle contours. For example, each pixel within 1, 2, 3 or more pixels from a sensed local peak, or from a pixel that is part of a particle contour, may be assigned the same luminance value as the luminance value of the local peak or member pixel of a particle contour. In this way, each island of particle contours may be stretched in size to define broadened particle contours. In some examples, user input may indicate how many neighboring pixels should have their luminance value adjusted, based on user knowledge of particle size or particle topography, or by experimentation (e.g., comparison against a calibration sample of known particle size or particle size distribution).

Additionally, or alternatively, particle contour broadener 224 may execute one or more computer vision or machine learning modules to determine how sensed particle contours should be stretched to determine broadened particle contours. In some examples, a fitting function may be executed to determine broadened particle contours. In some examples, the fitting function may be a Gaussian function, an adaptive mean threshold, an adaptive Gaussian function, combinations thereof, or another fitting function.

Once processing circuitry 204 has executed particle contour broadener 224 to determine broadened particle contours, processing circuitry may execute instructions to determine a particle boundary from the broadened particle contours. Stated similarly, processing circuitry 204 may be configured to determine which individual islands of particle contours in the sensed image data should be grouped together and assigned as belonging to the same particle, such that the particle boundary may be determined around the islands which are part of the same particle. In some examples, determining a boundary may include determining whether the broadened particle contours intersect with another spot or island of broadened particle contours. Based on determining that there is no intersection between the broadened particle contours, processing circuitry 204 may determine that the particle contour in the image data is a boundary of a particle. Conversely, based on the determination that there is intersection, determining that the particle contours and the other broadened particle contours together belong to the same particle, and connecting the islands of particle contours, and a line or curve set by a fitting function connecting the islands forms a boundary for the particle. As such, the determination that there is intersection between the broadened particle contours may include determining that the intersecting particle contours form a boundary for the at least one particle.

Once a particle boundary has been determined based on the broadened particle contours, processing circuitry 204 may be configured to mark the pixels within the boundary as making up an individual particle. Processing circuitry 204 may be configured to count the marked particles, size the particles within the image data by correlating the number of pixels to a scale that maps that the pixels to a map of the detection chamber and/or a zoom setting of the lens system of imager 110, and determine the concentration of particles within the fluid stream based on the marked particles and sampling information. As such, processing circuitry 204 may generate quantitative information based on the determined particle contours.

Processing circuitry 204 may execute the color manipulator 224 application, which may be housed within memory 202 of computing device 204. Processing circuitry 204 may execute color manipulator 218 to perform color analysis received color image data. The color image data may be from imager 110, which may be a color image sensor or a color video camera. The color image data may include colors in addition to black and white, such as one or more of red, green and blue colors.

In some examples, color manipulator 224 may store instructions for processing circuitry 204 to perform color analysis based on the determined particle boundary from the luminance analysis technique with the grayscale image data described above. For example, color analysis may be performed using the determined particle boundary as described above. Processing circuitry 204 may be configured to use determined particle boundary to locate a particle area in the color image data, such as by overlaying the determined particle boundary over the color image data from imager 110. Processing circuitry 204 may be configured to determine a dominant color within the particle area. In some examples, the dominant color may be the hue that appears most frequently within the particle area. In some examples, the dominant color may be the average of red, green, and blue values of pixels within the particle area. Processing circuitry 204 may convert the dominant color to the dominant wavelength of the particle by using the hue of the dominant color calculate the wavelength of induced fluorescent light emitted by the particle. The color image data may be signals sensed at red, green, and blue pixels in a sensor array of imager 110.

Processing circuitry 204 may be further configured to compare the dominant wavelength of the particle to a database of known wavelengths of particles stored within memory 202 as particle data 226. Since certain particles induce fluorescence at known wavelengths when irradiated with beam 116 of known wavelength, processing circuitry may thus determine a particle species when the dominant wavelength matches, or is within a certain tolerance, of a known particle species stored in the database. Similarly, memory 202 may store particles classification database(s) 203. These databases may use the dominant wavelength, size of the particle area, shape of the particle area, particle images of specific particles, or the like to classify particles by matching these features against known particle parameters stored within the database. Thus, processing circuitry 204 may be configured to generate qualitative information about at least one particle based on the determined particle contours.

In some examples, processing circuitry 204 may be configured to aggregate the results of frames of image data from imager 110, such as a first set of image data captured at a first time and a second set of image data captured at a second time. Processing circuitry 204 may be configured to output for display via display 206 a representation the first set of image data, the second set of image data, or both sets of image data. In some examples, the representation of the image data may be in the form of a chart, table or graph.

Advantageously, system 100 and its associated techniques for operation may be suitable for detecting and analyzing smaller particles than other particle detection and image processing techniques, because system 100 may process the sensed data to more accurately determine at least one of the shape, size, count, concentration, type, or species of particle. In some examples, system 100 may be suitable for detecting and analyzing particles that are smaller than 100 nanometers, such as less than 50 nanometers, in any dimension, such as smaller than 100 nanometer long, wide, or in diameter.

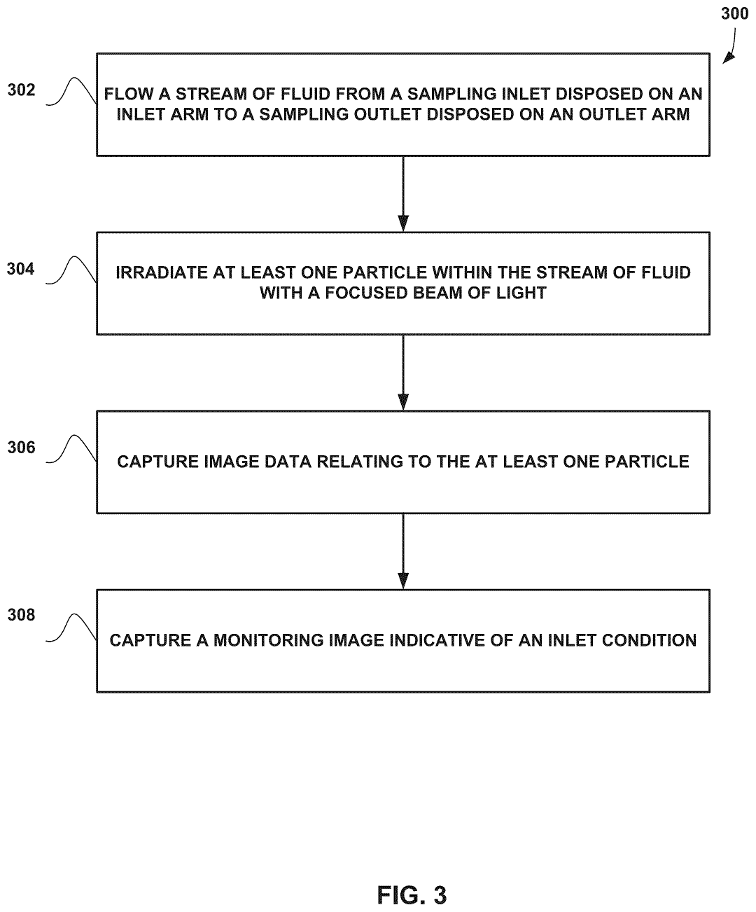

FIG. 3 is a flowchart illustrating an example particle analysis technique 300 in accordance with one or more aspects of the present disclosure. Although the illustrated technique is described with respect to, and may be performed by, system 100 of FIG. 1 and computing device 200 of FIG. 2, it should be understood that other systems and computing devices may be used to perform the illustrated technique. Technique 300 includes flowing stream of fluid 154 from inlet 104 on sampling arm 122 to outlet 108 disposed on outlet arm 124 (302). Technique 300 further includes irradiating, with light source 114, at least one particle within stream of fluid 154 with focused beam 116 (304). Technique 300 further includes capturing, with imager 110, image data relating to the at least one particle (306). In some examples, technique 300 may include capturing imaging data 214 (FIG. 2) with imager 110 (e.g., a color video camera). As discussed above, the imaging data may be induced or enhanced by light source 114, which may be external to imager 110. Technique 300 further includes capturing, in the image data relating to the at least one particle, a monitoring image indicative of an inlet condition (308). In some examples, capturing the monitoring image includes transforming, by light diffuser 106, focused beam 116 into expanded beam 117. (In some examples, technique 300 may further include projecting, optionally with one or more reflectors 118, expanded beam 117 to imager 110. In some examples, technique 300 may include analyzing, by processing circuitry 204, the received grayscale image data to identify at least one particle within the frame. Additionally, in some examples, technique 300 of FIG. 3 includes determining, by processing circuitry 204, particle contours of the at least one particle based on the luminance values. Furthermore, technique 300 may include generating, by processing circuitry 204, at least one of quantitative or qualitative information for the at least one particle based on the determined particle contours.

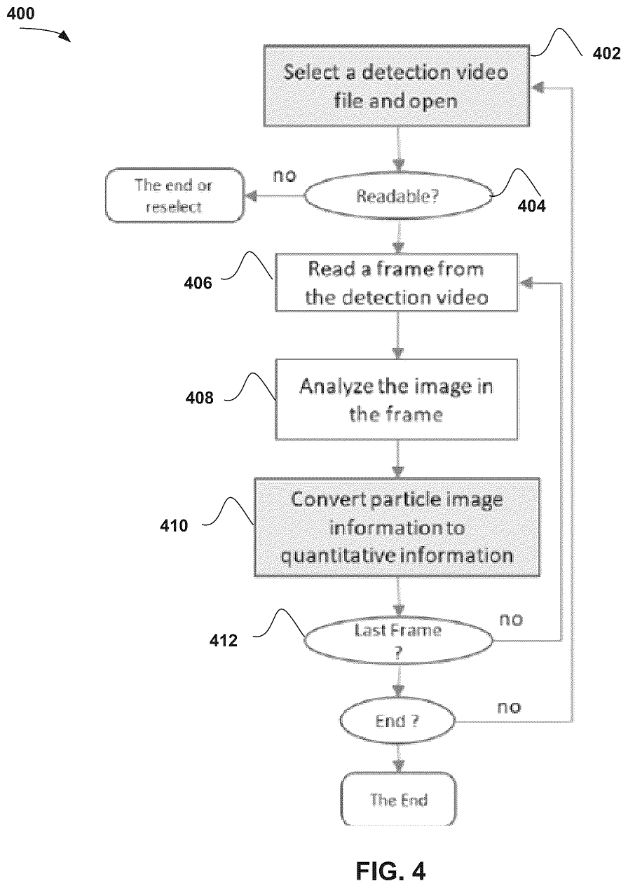

FIG. 4 illustrates an example particle detection and analysis technique 400 according to one or more aspects of the present disclosure. The technique includes selecting a file from an image sensor or camera 110 (402), which may be stored as imaging data 214 in memory 202. The technique includes determining, by processing circuitry 204, whether the file is readable (404). Responsive to determining that the file is readable, the technique includes reading a frame from the file by processing circuitry 204 (406). In some examples, the frame may represent image data sensed at a particular point in time. The technique includes analyzing, by processing circuitry 204, image data in the frame to identify at least one particle (408). The technique further includes converting, by processing circuitry 204, image data within the frame to quantitative information about the at least one particle (410). Optionally, the technique includes determining, by processing circuitry 204, whether the read frame is the last frame in the file (412). Responsive to determining that the read frame is not the last frame, the technique may optionally include reading a second frame from the file by processing circuitry 204. The second frame may be separated from the first frame by an adjustable duration of time, such that frame-by frame particle analysis may be conducted.

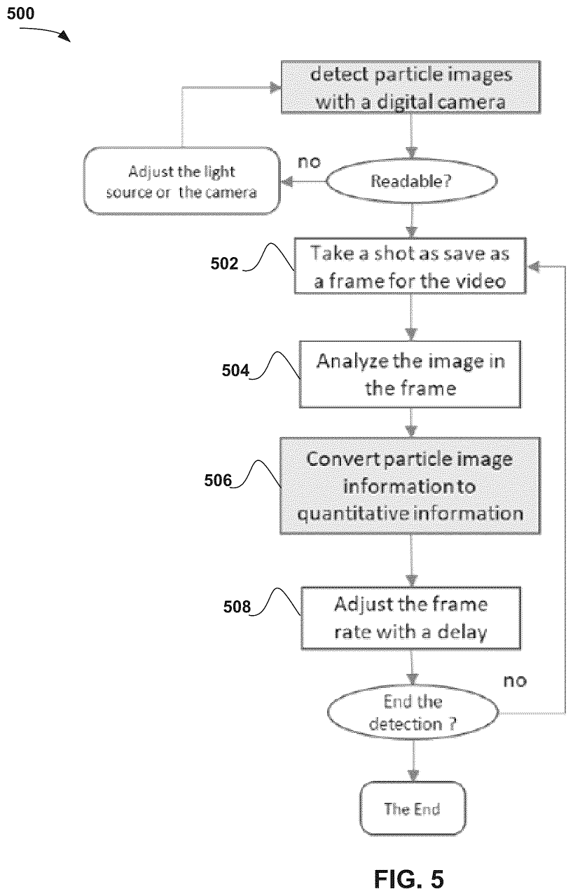

FIG. 5 is a flowchart illustrating an example real-time particle detection and analysis technique 500 in accordance with one or more aspects of the present disclosure. Although the illustrated technique is described with respect to and may be performed by system 100 of FIG. 1 and computing device 200 of FIG. 2, it should be understood that other systems and computing devices may be used to perform the illustrated technique. The technique includes receiving, by processing circuitry 204, image data from an imager 110. Imager 110 may be an image sensor or sensors or a camera or cameras, or a combination of sensors and cameras which may be located remotely from each other within detection chamber 102, may be configured to capture image data in different ways (e.g., induced fluorescence data or elastic light scattering data). Processing circuitry 204 may be configured to receive the image data in substantially real-time. The technique includes capturing, by processing circuitry 204, a first frame of the sensed image data representing data sensed at a first time, illustrated as “take a shot as save as a frame for the video” (502). The technique includes analyzing, by processing circuitry 204, the image data in the frame to identify at least one particle in the image data (504). The technique includes converting, by processing circuitry 204, image data within the frame to quantitative information about the at least one particle within the frame at the first time (506). The technique further includes, capturing, by processing circuitry, a second frame of the sensed image data representing data sensed at a second time. Optionally, the technique includes adjusting the frame rate with a delay, such that the duration of time between the first time and the second time is controlled (508). The frame rate may be controlled by processing circuitry 204 to allow a regular duration of time between successive frames, or may be input by a user through GUI 130 to manually capture frames at a selected time of interest. The technique optionally includes repeating the process with a third frame representing a third time, a fourth frame representing a fourth time, and so on. In some examples, the quantitative information may include one or more of a particle count, a particle concentration, an image size distribution, a wavelength distribution of induced fluorescence, or the like. The particle concentration, image size distribution, and wavelength distribution may be calibrated using particles of known concentrations, image sizes, and wavelengths.

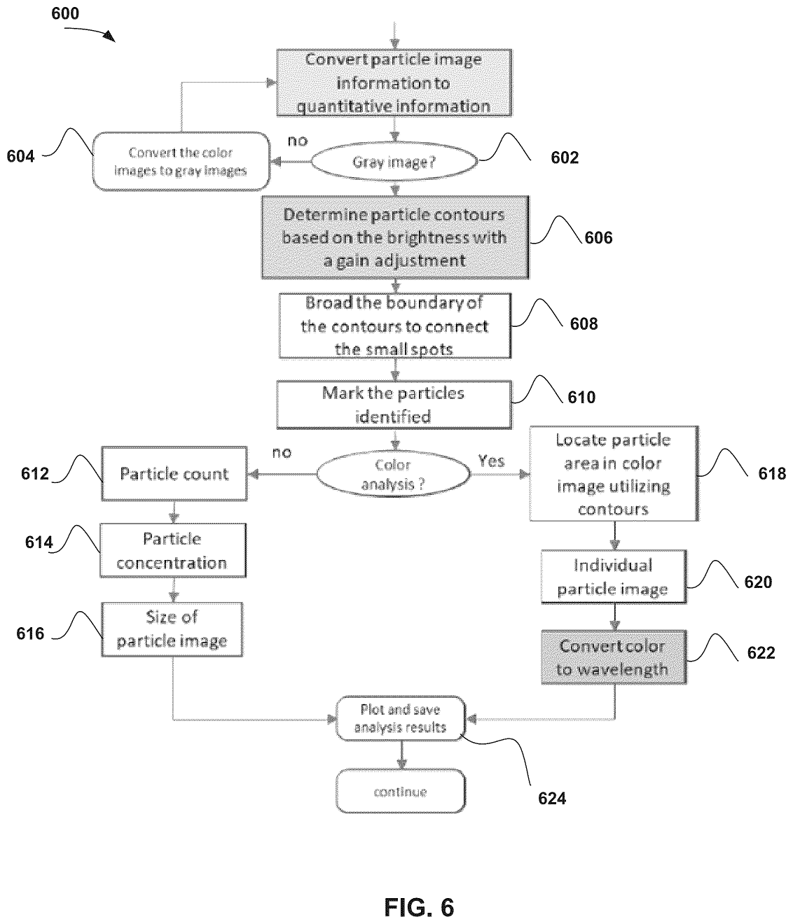

FIG. 6 illustrates an example technique 600 for converting sensed image data to quantitative and/or qualitative information about at least one particle. In some examples, technique 600 may be used to convert sensed image data to quantitative and/or qualitative information about at least one particle in the illustrated techniques of FIGS. 4 and 5, although other techniques may be employed to generate quantitative information in those techniques. Furthermore, the technique of FIG. 6 will be described with respect to system 100 of FIG. 1 and computing device 200 of FIG. 2, although the illustrated technique may be executed using other systems and computing devices.

The technique of FIG. 6 may include determining, by processing circuitry 204, whether the image is a gray image (602), and responsive to determining that the image is not a gray image, converting the image to a gray image (604). Color manipulator 218 may instruct processing circuitry 204 to the sensed and captured image data to change all or a portion of the captured image data to a gray image.

In some examples, the technique of FIG. 6 may include determining, by processing circuitry 204, particle contours of at least one particle in the image data sensed by imager 110 (606). Processing circuitry 110 may base the particle contours on the image brightness. The raw image data may be manipulated by gain adjuster 222 to increase or decrease the brightness in portions of the frame of sensed image data to determine an adjusted image brightness, which may be contained within luminance values of each pixel in a matrix of pixels making up the frame of image data. In some examples, the quality of determination of the contours may be evaluated by checking the ratio of the particle recognized to a known calibration sample of particles, and modifying processing circuitry 204 based on particle count differences, concentration differences, particle size or size distribution differences, particle type, or particle category differences between the known sample and the image data. For example, some particles in the calibration sample may be over or under recognized, and the settings of particle contour broadener 224 may be manipulated to more accurately capture the calibration sample. In the case of two or more parameters needed to change to determine the particle contours, in some examples only one may be selected as controllable by input by a user into GUI 130 and others may be pre-set by processing circuitry 204, to make the operation simple.

In some examples, the technique of FIG. 6 may include broadening the boundary of the determined particle contours by processing circuitry 204 through the particle contour broadener 224 application (608). The boundaries may be broadened by a selectable amount, such as, for example, 1 pixel, 2 pixels, 3 pixels, 1.5×, 2×, 3×, or the like, based on a user input. Additionally, or alternatively, one or more algorithms executed by processing circuitry 204 to determine how the sensed particle contours are broadened. For example, a user may input one setting, and processing circuitry 204 may execute a fitting function (e.g. a Gaussian function) to determine broadened particle boundaries. Furthermore, in some examples, processing circuitry 204 may, by recognizing where the adjusted (e.g., broadened) boundaries overlap, connect spots or islands of particle contours within the frame such that separate spots become one particle, and may be counted as such. Next, the technique of FIG. 6 may include marking, by processing circuitry 204, identified particles in the frame based on the determined particle contours (610). Discreet particles may be marked where the broadened particle contours do not overlap. Then, the technique of FIG. 6 may include counting, by processing circuitry 204, particles within the frame based on the broadened boundaries (612). The particle concentration may be calculated (614), which may based on the particle count and sampling data 220, which may include the volume of detection chamber 102, the flow rate of fluid through inlet 104, the energy supplied to pump 108, or the like. In some examples, the technique of FIG. 6 may include determining, by processing circuitry 2014, a size of at least one particle within the frame (616). The particle size may be based on image data from imager 110.

The technique of FIG. 6 may include only performing the steps on the left side of the color analysis split in FIG. 6. However, in some examples, the technique of FIG. 6 may also include performing color analysis. In some examples, the color analysis technique of FIG. 6 may be employed on the original color image captured by imager 110. Performing color analysis may include locating, by processing circuitry 204, a particle area in the frame color image utilizing contours, as described above (618). In some examples, performing color analysis may include forming an individual particle image (620). In some examples, technique 600 may include converting, by processing circuitry 204, color to wavelength by using the hue of color in the color image to calculate the wavelength of induced fluorescent light, as will be further described below (622). Converting color to wavelength by processing circuitry 204 may be based at least partially on the signals sensed at red, green, and blue pixels in a sensor array of image sensor 110.

In some examples, the technique of FIG. 6 may include comparing, by processing circuitry 204, the wavelength of induced fluorescence of an identified particle to a database of known wavelengths of particles stored as particle data 226 in memory 202. In some examples, a threshold for comparing the wavelength of the sensed particle may be met, and a particle species may be determined. Similarly, the technique of FIG. 6 may include, by comparing, with processing circuitry 204, the sensed color image to a particles classification database 203 stored in memory 202.

In some examples, the technique of FIG. 6 may include outputting, by processing circuitry 204, for display via a display such as GUI 130, a representation of one or more pieces of quantitative information from the frame of sensed data (624). The quantitative information may include one or more of a particle count, a particle size, a particle concentration, a particle type, or a particle species. In some examples, the quantitative or qualitative information may be associated with reflector data 234 and/or an engine associated with sampled pipe 150, such as by registering image data 214 captured by imager 110. The technique of FIG. 6 may include displaying the results on a display, such as a display associated with GUI 130.

FIG. 7A is a schematic illustration of an example image captured by imager 110. The captured image may reflect the configuration of system 100 of FIG. 1. As such, the below description refers concurrently to FIGS. 1 and 7A-7D, as well as FIG. 2. The captured image of FIG. 7A represents a portion of the inside detection chamber 102. The captured image includes light source 114 generating and emitting focused beam 116, which irradiates particles 190A, 190B, and 190C, among other particles suspended with detection chamber 102. The captured image also illustrates reflector 118. The area of the captured image displaying reflector 118 may be called monitoring image 121. Monitoring image 121 may be the portion of the image data captured by imager 110 that is indicative of a sampling condition of system 100. FIGS. 7B-7D are schematic illustrations of monitoring image 121 of reflector 118 of FIG. 7A in various operating conditions. As such, FIGS. 7B-7D are different monitoring images 121. Reflector 118 of FIGS. 7A and 7B is lit up by expanded beam 117 (FIG. 1, not illustrated in FIG. 7A), which is shown as causing reflector 118 to be white in color. Furthermore, the entire perimeter of reflector 118 is visible on monitoring image 121 of 7A and 7B. As such, inlet arm 122 (FIG. 1) may not include particles or agglomerations blocking inlet arm 122 and occluding expanded beam 117 from reaching reflector 118 and projected to imager 110, resulting in monitoring image 121 of FIGS. 7A and 7B being free from occlusions which would be caused by a partially blocked inlet arm 122. When monitoring image 121 of FIGS. 7A and 7B is captured by imager 110, processing circuitry 204 may execute self-checker 232 (FIG. 2), to determine that inlet arm 122 is clean and/or that an inlet condition is suitable for operation of system 100.

In examples where reflector 118 does not project any portion of expanded beam 117 to imager 110, illustrated by monitoring image 121 of FIG. 7C being totally black. In such a condition, processing circuitry 204 may execute self-checker 232 to determine that an error has occurred with light source 114 and/or imager 110. In such a condition, processing circuitry 204 may be configured to execute self-checker 232, determine that not portion of expanded beam 117 has reached reflector 118, and may be configured to output a signal, such as an alarm, an error code, a warning signal, or the like, indicating that the light source 114 or imager 110 has faulted in some way. Referring to FIG. 7D, a portion of reflector 118 is lit up on monitoring image 121, indicating that light source 114 and imager 110 are operating. Lit up, as described herein, may refer to a condition where a luminance value is above a threshold luminance value. However, a portion of the surface area of reflector 118 is dark on monitoring image 121 (e.g., the luminance values of some pixels are below a threshold luminance value), indicating that expanded beam 117 is being occluded within inlet arm 122 by particle 190D. 190E, which may agglomerate and foul inlet 102 and/or inlet arm 122. Particles 190D, 190E may occlude expanded beam 117, such that only a portion of light from expended beam 117 is projected to reflector 118 and imager 110 and thus captured as monitoring image 121. In some examples, the portion of pixels which satisfy a threshold luminance value in monitoring image 121 may be indicative of a level of openness of inlet 104. The level of openness of inlet 104 may be the condition of inlet 104. In this way, monitoring image 121 captured by imager 110 may indicate a condition of inlet 104 as clean, partially blocked, or faulted. Although primarily described herein as monitoring inlet 104, it will be understood that a monitoring image of outlet arm 124 (FIG. 1) and outlet 108 (FIG. 1) could be captured additionally or alternatively to monitoring image 121.

In some examples, processing circuitry 204 may be configured to execute self-checker 232 to analyze monitoring image 121 of reflector 118 to determine whether the inlet condition satisfies a threshold level of openness. For example, reflector data 234 may store information indicative of the location of pixels of reflector 118, and luminance values of those pixels within the region of the captured image identified as within reflector 118. Processing circuitry 204 may assign each pixel within the region as blocked when the luminance value falls below a threshold luminance value, and open when the luminance value meets or exceeds a luminance value threshold. Then, in some examples processing circuitry 204 may determine a ratio of blocked pixels top open pixels as a percentage of the total area of the pixels indicative of reflector 118 on monitoring image 121. If the percentage of open pixels exceed a threshold, which may be set manually, or include a default threshold, or set another way, processing circuitry 204 may determine that the inlet condition satisfies a threshold level of openness. In some examples, responsive to determining that the inlet condition does not satisfy the threshold level of openness, processing circuitry 204 may flag the image data captured by imager 110. In some examples, the flagged image data may indicate that the image was captured at a point in time when inlet 104 did not satisfy the inlet condition. Accordingly, in some examples, this flagged data may be discarded. Additionally, or alternatively, processing circuitry 204 may be configured to output an alarm, indicator, or other warning signal that the inlet condition does not satisfy the threshold level of openness. The alarm or warning signal may display on display 132, or may be propagated to another display associated with an engine of sampled pipe 150. In some examples, the alarm or warning signal is indicative that inlet 104 and/or 122 should be cleaned, such that particles 190D, 190E may be removed and the threshold level of openness may be regained.

In some examples, in addition to or alternatively to determining whether the inlet condition meets the threshold level of openness by analzying monitoring image 121 of reflector 118, system 100 may employ pressure differential sensor 134 to determine or confirm that stream of fluid is flowing through system 100 correctly. Pressure differential sensor 134 may include a pressure probe disposed in inlet arm 122, and a second pressure probe in outlet arm 124, as illustrated in FIG. 1. As such, pressure differential sensor 134 may be configured to sense and monitor a pressure drop across system 100 between inlet arm 122 and outlet arm 124. The monitored pressure drop across system 100 may increase when at least a portion of system 100 is fouled, indicating that flow of stream of fluid 154 is constricted. In some examples, processing circuitry 204 may be configured to flag image data when the pressure drop measured by pressure differential sensor 134 is above a pressure threshold. Processing circuitry 204 may be configured to flag image data captured by imager 110 when the pressure drop is above the pressure threshold. In some examples, pressure differential sensor 134 may be configured to output an alarm, indicator, or other warning signal that the inlet condition does not satisfy the threshold level of openness. The alarm or warning signal may display on display 132, or may be propagated to another display associated with an engine of sampled pipe 150. In some examples, the alarm or warning signal is indicative that inlet 104 and/or 122 should be cleaned, such that the threshold level of openness may be regained.

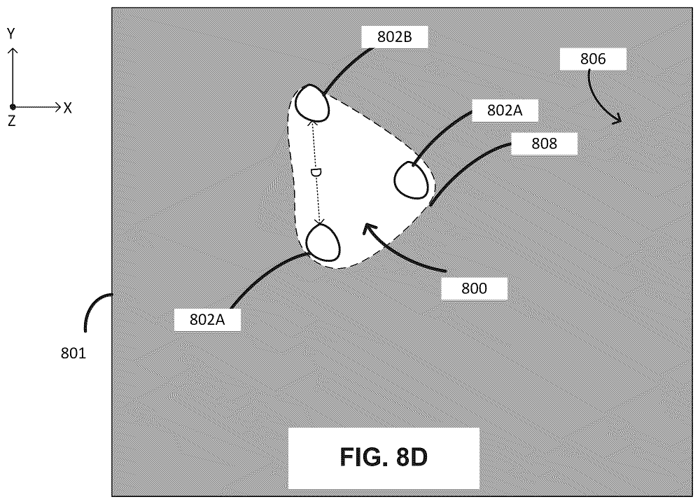

FIGS. 8A, 8B, 8C, and 8D are schematic illustrations of various representations of example particle 800. FIG. 8A illustrates a frame 801 where an imager (e.g., imager 110, FIG. 1) captured particle 800 from a side view against background 806. Frame 801 may be a portion, such as a zoomed in portion of the overall view of imager 110, which may be illustrated in FIG. 7A. Frame 801 is illustrated in dashed lines on FIG. 7A. Particle 800 may be irradiated by a beam (116, FIG. 1) from light source 114 (FIG. 1). FIGS. 8B, 8C, and 8D illustrate frames where an imager such as imager 110 of FIG. 1 captured example particle 800 from a top view, such as a frame at a different time (e.g. a second time) where suspended particle 800 has rotated relative to imager 800 within a stream of fluid. As illustrated in FIG. 8A, particle contours 802A, 802B, 802C, 802D define various portions of particle 800.

FIG. 8B illustrates image data before particle contour broadener 224 (FIG. 2) broadens particle contours 802A, 802B 802C, while FIG. 8C illustrates broadened particle contours 804A, 804B, 804C, 804D. Particle contours 802A, 802B, and 802C define islands or spots in FIG. 8B, because imager 110 may only capture and record the top of the spikes of particle 800 due to the topography of irregularly shaped particle 800, the zoom of imager 110, or both. As illustrated, absent particle contour broadening, the islands defined by particle contours 802A, 802B, 802C may be counted as three small individual particles, resulting in overcounting and undersizing particle 800. After application of contour broadening in FIG. 8C, broadened particle contours are stretched relative to their original size to generate broadened particle contours 804A, 804B, and 804C as discussed above. Processing circuitry 204 (FIG. 2) may determine that broadened particle contours 804A, 804B, and 804C intersect at points 810A, 810B, and 810C. Responsive to determining that the broadened particle contours intersect, processing circuitry 204 (FIG. 2) may be configured to determine that boundary 808 should be determined such that particle 800 includes all three particle contours 802A, 802B, 802C. In some examples, as illustrated in FIG. 8C, particle boundary 808 may be based on broadened particle contours 804A, 804B, and 804C, and in some examples boundary 808 may surround the broadened particle contours. Alternatively, as best illustrated in FIG. 8D, particle boundary 808 may surround non-broadened particle contours 802A, 802B, and 802C. In some examples, boundary 808 may define straight lines connecting particle contours, or may be defined by a fitting function as described above.

With continued reference to FIG. 8D, in some examples, determining a boundary based on broadened particle contours, processing circuitry 204 may simply be configured to measure the distance D between defined particle contours 802A and 802B, and determining that distance D is less than a threshold distance between particles. Particle boundary 808 may be determined to surround both particle contours based on this determination. Thus, as demonstrated in FIGS. 8A-8D, the disclosed systems and techniques may more accurately count and size particle 800 than other particle detection and analysis techniques.

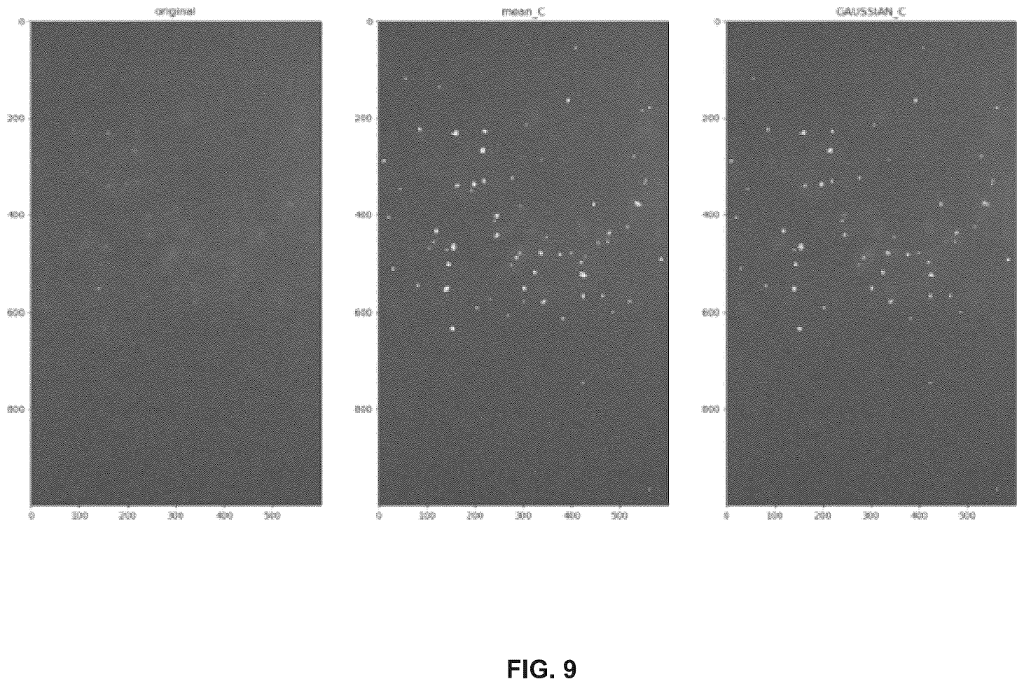

FIG. 9 is a set of pictures illustrating the results of particle detection and image processing techniques in accordance with one or more aspects of the present disclosure. Several methods, such as the adaptive mean threshold and the adaptive Gaussian threshold, have been tested to determine the particle contours. FIG. 9 illustrates the original picture from a particle detection video (left) and the pictures after the particle recognition with marks for the identified particle (middle and right).

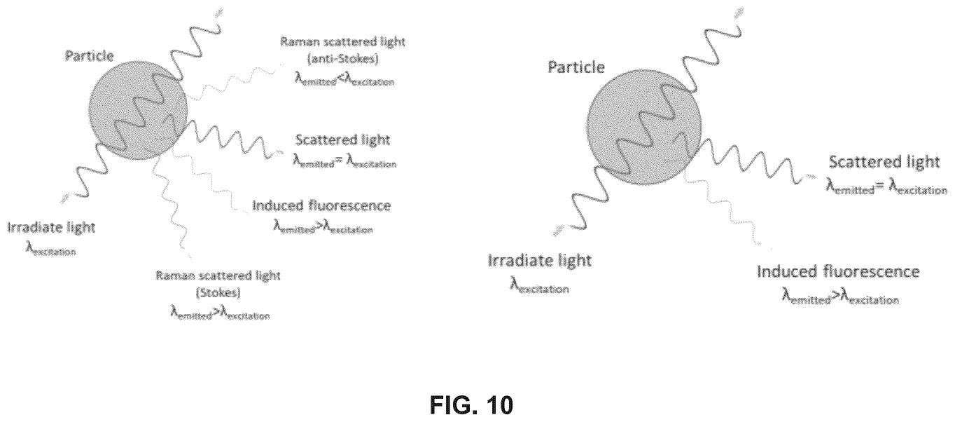

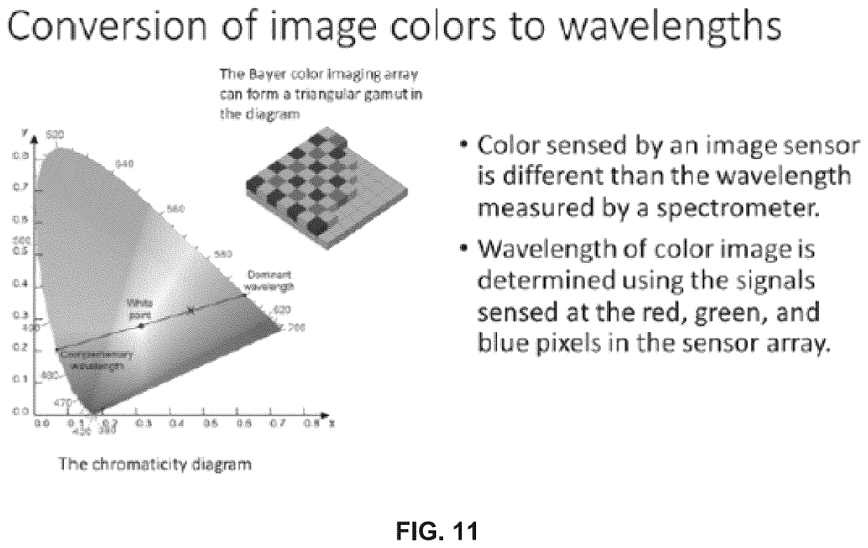

FIG. 10 are schematic conceptual views illustrating example reactions from a particle under irradiation by a light source. Referring to the picture on the left, irradiation of the particle by, for example, light source 114 (FIG. 1) may occur at an excitation wavelength. When light rays in beam 116 (FIG. 1) contact a particle, several rays may result, including Raman (Stokes) scattered light, which may be at a wavelength less than the wavelength of excitation, induced fluorescence, which also may be at a wavelength less than the wavelength of excitation. Irradiation may further result in scattered light, which may be equal to the wavelength of excitation, and Raman (anti-Stokes) scattered light, which may be at a wavelength greater than the wavelength of excitation. On the right, the types of light which may be utilized in some examples of the current disclosure, for example scattered light and induced fluorescence. In some examples, the Raman scattered light may be filtered before reaching imager 110.

FIG. 11 illustrates an example chromaticity diagram for determining a color hue used to calculate a dominant wavelength in accordance with one or more aspects of the present disclosure. The conversion of the color to the wavelength of induced fluorescence in systems and techniques may be based on the concept of dominant wavelength in the color chromaticity diagram. The hue of the color image of a particle, derived from the signals from red, green, and blue sensing pixels, is the major parameter used for converting the color to the wavelength. The effect of saturation and brightness on the conversion is considered. In some examples, the calculated wavelength calculated by processing circuitry 204 may be adjusted or calibrated, using particles with known emitted wavelength. In some examples, more than calibrating wavelength may be used.

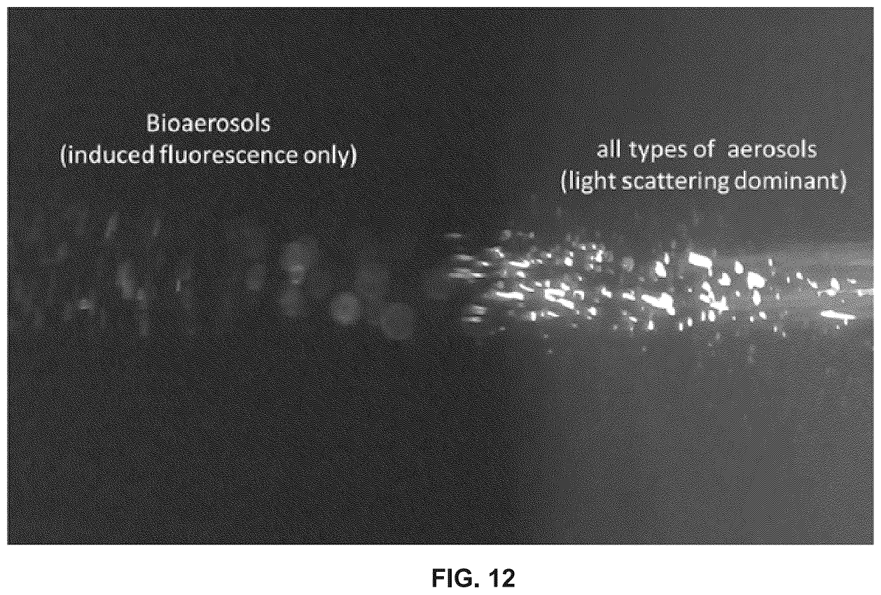

FIG. 12 illustrates an example color image in accordance with one or more aspects of the present disclosure. As illustrated in some examples imager 110 may be a single imager that is configured to capture both induced fluorescence and light scattering image data within the same frame. For example, a portion of the frame of imager 110 may be filtered, such that the sensed and captured image data matrix captures different types of light. In this way, light scattered or emitted by certain types of particles may be distinguished from light scattered or emitted by other types of particles. In this way, bioparticles may be sensed by systems and techniques of the present disclosure. In some examples, induced fluorescence from bioaerosols may be captured without noise from other particles.

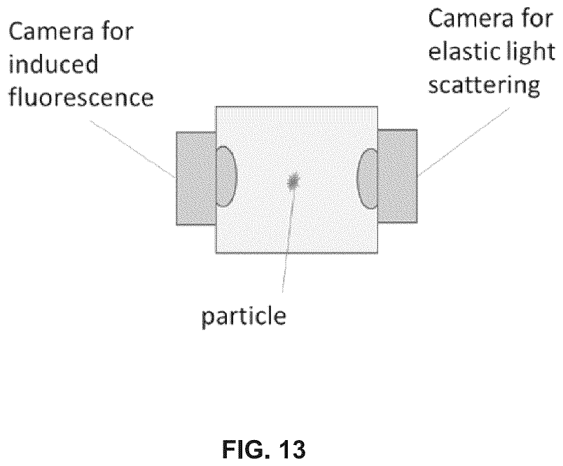

FIG. 13 is a schematic diagram illustrating a portion of an example system in accordance with one or more aspects of the present disclosure. In some examples imager 110 of FIG. 1 may include more than one image sensor or camera. In some examples, one camera, which may be a color video camera, may be configured to capture image data corresponding to induced fluorescence image data, and the second camera, which may also be a color video camera, may be configured to capture image data corresponding to elastic light scattering image data.

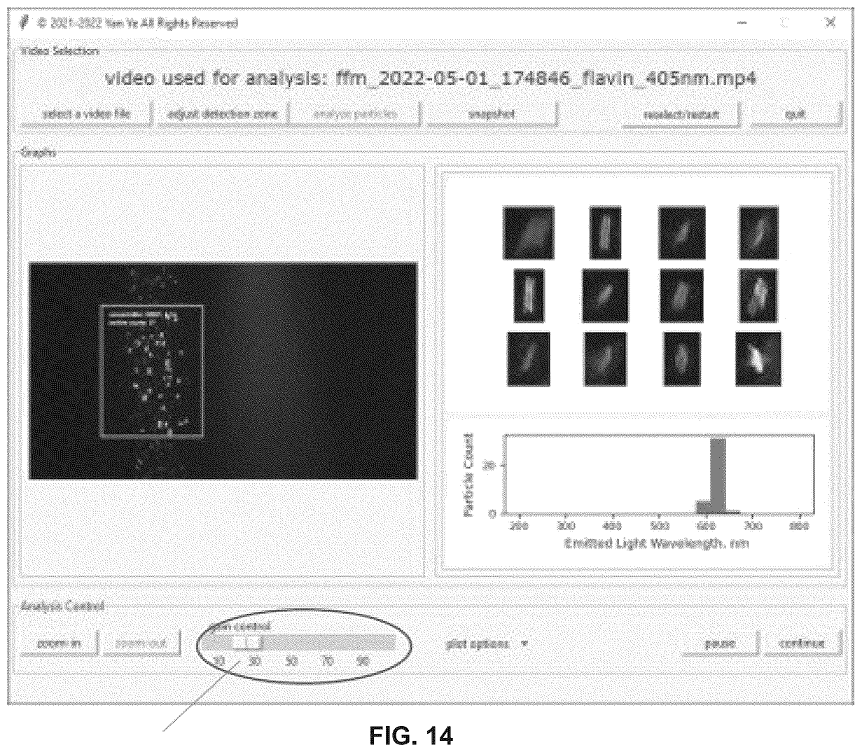

FIG. 14 illustrates example screenshots from a display in accordance with one or more aspects of the present disclosure. The illustrated example illustrates how a GUI such a GUI 130 of FIG. 1 may facilitate easy interaction the disclosed systems to perform the disclosed techniques. As circled, the user interface may present a knob to adjust particle detection effectiveness, for example by adjusting a gain control to increase particle image recognition. Also as discussed above, the settings may be placed in manual or auto mode. As described above, an adaptive Gaussian threshold may be used to distinguish between light scattering particles and background.

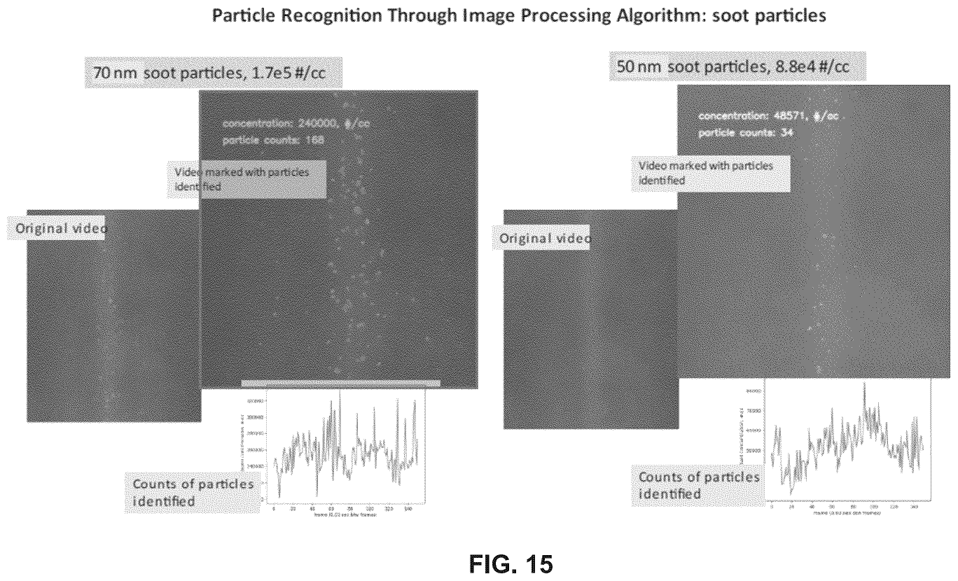

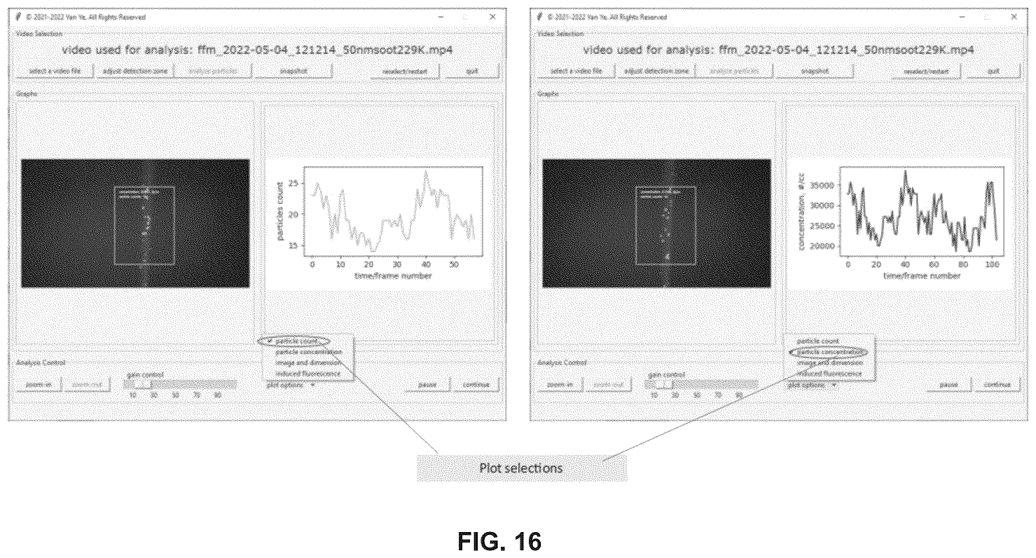

FIG. 15 illustrates example results from particle recognition tests on soot particles through the disclosed image processing techniques and systems. The soot particles may be similar to those particles flowing in stream of fluid 152 through sampled pipe 150 of FIG. 1. As mentioned above, sampled pipe 150 may be attached to a diesel engine. As illustrated on the left, the disclosure provides for detection and analysis of particles less than or equal to 70 nm in size, where the soot particles are not visible in the original video. Even further, the disclosure provides for detection and analysis of particles less than 50 nm in size, where the soot particles are not visible in the original video.

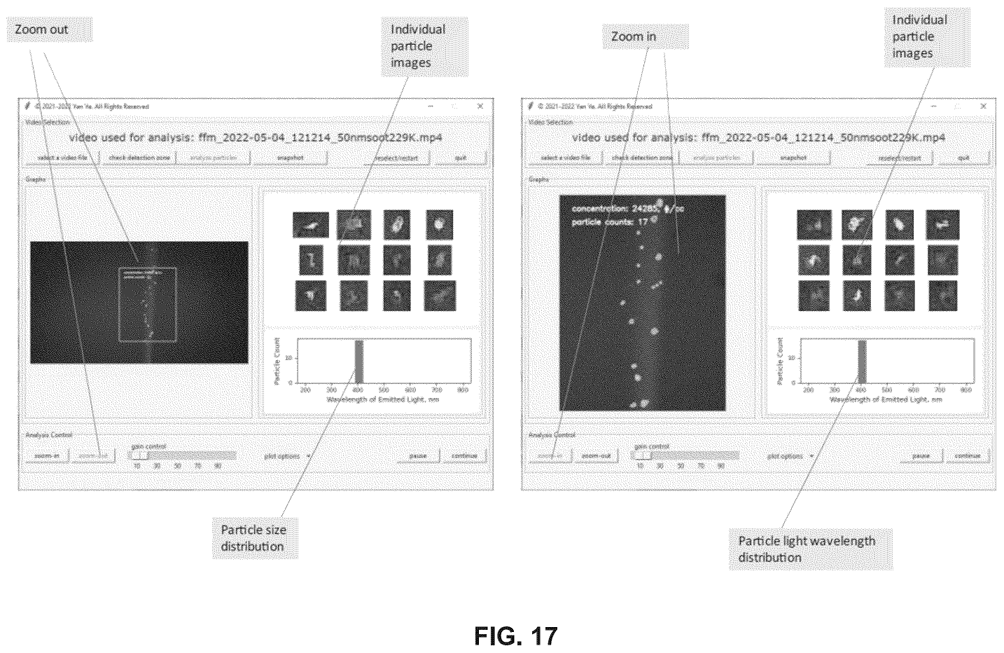

FIG. 17 illustrates example screenshots from an example display according to the present disclosure. As illustrated, one or more of the qualitative or quantitative information regarding at least one particle may be selected for display by a user.

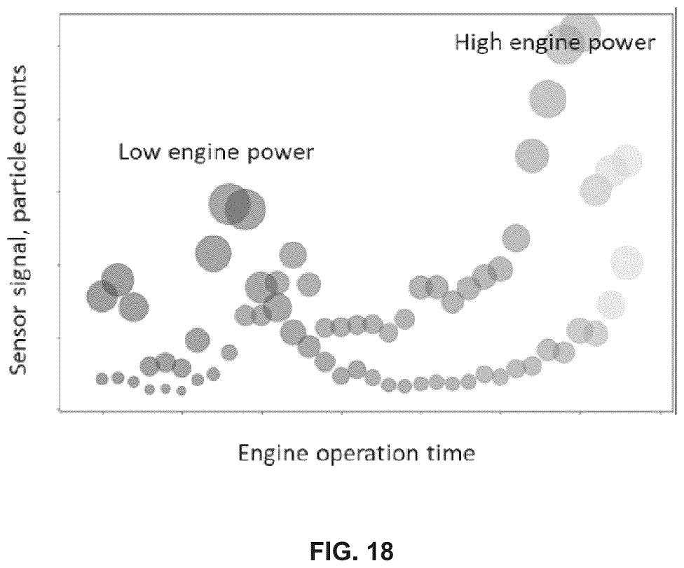

FIG. 18 illustrates a conceptual screenshot from an example display according to the present disclosure. As mentioned above, data relating to an engine associated with sampled pipe 150 may be integrated and plotted with data from system 100. As illustrated, operational data form the engine may be compared to data from system 100, which may assist in determining performance characteristics of the engine at various operational settings. Additional features and functionality are illustrated to demonstrate the qualitative and quantitative information the disclosed systems and techniques are capable of generating.

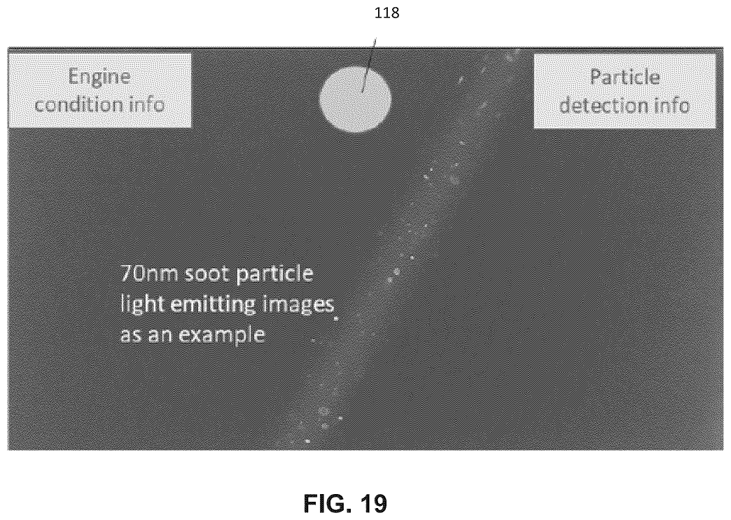

FIG. 19 illustrates example screenshots from an example display according to the present disclosure demonstrating additional features and functionality are illustrated to further demonstrate systems and techniques according to the present disclosure. For example, engine condition information may be displayed with particle detection information and an indication of the condition of inlet on reflector 118, as described above.

One or more of the techniques described in this disclosure may be implemented, at least in part, in hardware, software, firmware or any combination thereof. For example, various aspects of the described techniques may be implemented within one or more processors or processing circuitry, including one or more microprocessors, digital signal processors (DSPs), application specific integrated circuits (ASICs), field programmable gate arrays (FPGAs), graphics processing units (GPUs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, circuits or components may be implemented together or separately as discrete but interoperable logic devices. Depiction of different features as circuits or units is intended to highlight different functional aspects and does not necessarily imply that such circuits or units must be realized by separate hardware or software components. Rather, functionality associated with one or more circuits or units may be performed by separate hardware or software components or integrated within common or separate hardware or software components.

Various examples have been described. These and other examples are within the scope of the following claims and clauses:

Clause 1. A system comprising: an inlet arm including a sampling inlet; an outlet arm including a sampling outlet, wherein a stream of fluid is configured to flow from the sampling inlet to the sampling outlet; a particle sensor disposed between the sampling inlet and the sampling outlet, the particle sensor comprising: at least one light source of a certain wavelength configured to irradiate at least one particle within the stream of fluid with a focused or collimated beam of light; at least one image sensor or camera configured to capture image data relating to the at least one particle; and at least one light diffuser or reflector configured to form at least one monitoring image in the image data captured by the image sensor or camera relating to the at least one particle, wherein the monitoring image is configured to indicate an inlet condition of the sampling inlet or inlet arm.

Clause 2. The system of clause 1, further comprising a light diffuser configured to transform the focused beam of light from the light source to an expanded beam, wherein the expanded beam is configured to project to the particle image sensor to form the monitoring image.

Clause 3. The system of clause 1, further comprising one or more processors configured to: obtain a frame of grayscale image data comprising luminance values of image data captured by the image sensor or camera; analyze the image data in the frame to identify at least one particle captured in the frame, wherein to analyze the image data, the one or more processors are configured to: identify pixels having luminance values that satisfy a luminance threshold; and determine particle contours of the at least one particle based on the identified pixels; and generate at least one of quantitative or qualitative information for the at least one particle based at least partially on the analyzing of the image data.

Clause 4. The system of clause 3, wherein the one or more processors is further configured to: determine whether the inlet condition satisfies a threshold level of openness; and responsive to determining that the inlet condition does not satisfy the threshold level of openness, flag image data captured by at least one image sensor.

Clause 5. The system of any of clauses 1-4, further comprising a detection chamber between the sampling inlet and the sampling outlet and housing the particle sensor.

Clause 6. The system of clause 5, wherein the inlet arm extends away from the detection chamber such that the sampling inlet is located in a central portion of a sampled pipe and receives the stream of fluid from the central portion of the sampled pipe.

Clause 7. The system of clause 5 or clause 6, wherein the outlet arm extends away from the detection chamber such that the sampling outlet is configured to output the stream of fluid near a wall of the sampled pipe outside of the central portion of the sampled pipe.

Clause 8. The system of any of clauses 1-7, further comprising a light diffuser and a reflector, wherein the reflector is configured to reflect incident waves of light from the light diffuser to the image sensor or camera.

Clause 9. The system of any of clauses 1-8, wherein the stream of fluid is sourced from the sampled pipe and configured to flow from the sampling inlet to the sampling outlet driven by a pressure difference naturally formed by the particle sensor, without using an external device supplying an additional power.

Clause 10. The system of any of clauses 1-9, further comprising a differential pressure sensor between the sampling inlet and the sampling outlet.

Clause 11. The system of any of clauses 1-10, further comprising one or more additional chemical or physical sensors configured to determine one or more parameters of the stream of fluid.

Clause 12. The system of any of clauses 1-11, wherein the light source is an external light source, wherein the light source comprises a laser or LED, and wherein the light source generates a beam of light with a wavelength below 450 nanometers (nm), such as from about 250 nm to about 350 nm.

Clause 13. The system of any of clauses 1-12, wherein the captured image data comprises image data of fluorescence induced or elastic light scattered from at least one particle by the light source.

Clause 14. The system of any of clauses 1-13, wherein the image sensor or camera comprises a color image sensor or camera, such as a color video camera.

Clause 15. The system of any of clauses 1-14, wherein the image data includes a red image data matrix, a green image data matrix, and a blue image data matrix, and wherein the one or more processors is further configured to obtain grayscale image data by at least one of summing or averaging each of the red image data matrix, the green image data matrix, and the blue image data matrix to form an overall image data matrix.

Clause 16. The system of any of clauses 1-15, wherein the one or more processors is further configured to identify pixels having luminance values that satisfy a threshold, wherein identifying pixels comprises: determining local thresholds within respective subsets of pixels; comparing luminance values of pixels within each respective subsets of pixels to respective local threshold for that subset of pixels; and sweeping through the subsets to pixels to identify the pixels based on the comparison, and wherein determining particle contours comprises grouping the identified pixels of each of the respective subsets of pixels together as an island of particle contours.

Clause 17. The system of clause 16, wherein determining the local thresholds comprises averaging pixel values of the image data within the respective subsets of pixels.

Clause 18. The system of clause 16, wherein the one or more processors is further configured to identify adjacent islands of particle contours as belonging to the same particle, and determining particle contours by fitting the data in the subsets of pixels using a fitting function.

Clause 19. The system of clause 18, wherein the fitting function is a Gaussian function.

Clause 20. The system of any of clauses 1-19, wherein identifying pixels having luminance values that satisfy the threshold comprises: determining the threshold within the image data; comparing luminance values of pixels to the threshold; and identifying the pixels based on the comparison, and wherein determining particle contours comprises grouping the identified pixels together as an island of particle contours.

Clause 21. The system of clause 20, wherein determining the local thresholds comprises averaging pixel values of the image data within the respective subsets of pixels.

Clause 22. The system of any of clauses 1-21, wherein the one or more processors is further configured to: apply a gain adjustment to the luminance values to determine adjusted luminance values for one or more pixels, wherein identifying pixels that satisfy the threshold comprises identifying pixels that satisfy the threshold based on the adjusted luminance values.

Clause 23. The system of any of clauses 1-22, wherein the identified pixels comprises a first pixel and a second pixel that are separated by a distance, wherein the one or more processors is configured to determine particle contours by: assigning one or more pixels, within the distance, proximate to the first pixel and second pixel approximately the same luminance value as nearest pixel within identified pixels to create a broadened cluster of pixels that include the first pixel and the second pixel; and determining the particle contours based on the cluster of pixels.

Clause 24. The system of any of clauses 1-23, wherein the one or more processors are configured to generate at least one of quantitative or qualitative information by generating quantitative information comprising at least one of a particle count or a particle concentration.

Clause 25. The system of any of clauses 1-24, wherein the one or more processors is configured to generate at least one of quantitative or qualitative information by generating qualitative information comprising images of individual particles, sizes of the captured particles represented by the image data, and colors or dominant wavelengths of induced or enhanced light emitting from the captured particles.

Clause 26. The system of any of clauses 1-25, wherein the one or more processors is further configured to: select a file from a memory associated with the image sensor or color image data directly camera; and read a frame from the file to generate the grayscale image data.

Clause 27. The system of clause 26, wherein the file comprises video data.

Clause 28. The system of clause 27, wherein the one or more processors is further configured to: determine whether the file contains at least one additional frame, and responsive to determining that the file contains at least one additional frame, read a second frame from the file to generate a second set of grayscale image data.

Clause 29. The system of any of clauses 27 or 28, wherein the one or more processors is configured to generate at least one of quantitative or qualitative information for the at least one particle based at least partially on the determined particle contours by marking the at least one particle within the image data based on the determined boundary.

Clause 30. The system of clause 29, wherein the one or more processors is further configured to count the marked at least one particle.

Clause 31. The system of clause 30, wherein the one or more processors is configured to determine a particle concentration based on the counted at least one particle.

Clause 32. The system of clause 30 or clause 31, wherein the one or more processors is configured to determine the size of at least one particle within the frame based on the determined boundary.

Clause 33. The system of any of clauses 1-32, wherein the one or more processors is further configured to: receive color image data that includes colors in addition to black and white, wherein the color image data is from the image sensor or camera, and wherein the grayscale image data is based on the color image data; perform color analysis on the color image data using the determined particle contours, generate at least one of the quantitative or qualitative information comprises generating qualitative information based on the color analysis.

Clause 34. The system of clause 33, wherein performing color analysis comprises locating a particle area in the color image data.

Clause 35. The system of clause 26, wherein performing color analysis comprises determining a dominant color within the particle area.

Clause 36. The system of any of clauses 33-35, wherein performing color analysis comprises converting the dominant color to a dominant wavelength of the at least one particle by using the hue of the color image data to calculate the wavelength of induced fluorescent light emitted by the at least one particle.

Clause 37. The system of clause 36, wherein converting the dominant color to a dominant wavelength of at least one particle is based at least partially on signals sensed at red, green, and blue pixels in a sensor array of the image sensor.

Clause 38. The system of clause 37, wherein the one or more processors are configured to compare the dominant wavelength of at least one particle to a database of known wavelengths to determine a particle species.

Clause 39. The system of any of clauses 1-38, further comprising outputting, for display via a display, a representation of one or more pieces of the at least one of quantitative or qualitative information, wherein the at least one of quantitative or qualitative information comprises one or more of a particle count, a particle size, a particle concentration, a particle type, or a particle species.

Clause 40. The system of any of clauses 1-39, wherein at least one particle is smaller than 100 nanometers in diameter.

Clause 41. The system of any of clauses 1-40, further comprising the sampled pipe, wherein the sampled pipe is fluidically connected to a diesel engine.

Clause 1B. A method of suspended particle detection comprising: flowing a stream of fluid from a sampling inlet disposed on an inlet arm to a sampling outlet disposed on an outlet arm of a particle sensor; irradiating at least one particle within the stream of fluid with a focused beam of light from a light source; capturing, with an image sensor or camera of the particle sensor, image data relating to the at least one particle; and capturing, in the image data relating to the at least one particle, a monitoring image indicative of an inlet condition of the sampling inlet or inlet arm.

Clause 2B. The method of clause 1B, further comprising performing the method of any of clauses 2-41.

1. A system comprising:
an inlet arm including a sampling inlet;
an outlet arm including a sampling outlet, wherein a stream of fluid is configured to flow from the sampling inlet to the sampling outlet;
a particle sensor disposed between the sampling inlet and the sampling outlet, the particle sensor comprising:
at least one light source of a certain wavelength configured to irradiate at least one particle within the stream of fluid with a focused or collimated beam of light;
at least one image sensor or camera configured to capture image data relating to the at least one particle; and
at least one light diffuser or reflector configured to form at least one monitoring image in the image data captured by the image sensor or camera relating to the at least one particle, wherein the monitoring image is configured to indicate an inlet condition of the sampling inlet or inlet arm.

2. The system of claim 1, further comprising a light diffuser configured to transform the focused beam of light from the light source to an expanded beam, wherein the expanded beam is configured to project to the particle image sensor to form the monitoring image.

3. The system of claim 1, further comprising one or more processors configured to:
obtain a frame of grayscale image data comprising luminance values of image data captured by the image sensor or camera;
analyze the image data in the frame to identify at least one particle captured in the frame, wherein to analyze the image data, the one or more processors are configured to:
identify pixels having luminance values that satisfy a luminance threshold; and
determine particle contours of the at least one particle based on the identified pixels; and
generate at least one of quantitative or qualitative information for the at least one particle based at least partially on the analyzing of the image data.

4. The system of claim 3, wherein the one or more processors is further configured to:
determine whether the inlet condition satisfies a threshold level of openness; and
responsive to determining that the inlet condition does not satisfy the threshold level of openness, flag image data captured by at least one image sensor.

5. The system of claim 1, further comprising a detection chamber between the sampling inlet and the sampling outlet and housing the particle sensor.

6. The system of claim 5, wherein the inlet arm extends away from the detection chamber such that the sampling inlet is located in a central portion of a sampled pipe and receives the stream of fluid from the central portion of the sampled pipe.

7. The system of claim 5, wherein the outlet arm extends away from the detection chamber such that the sampling outlet is configured to output the stream of fluid near a wall of the sampled pipe outside of the central portion of the sampled pipe.

8. The system of claim 1, further comprising a light diffuser and a reflector, wherein the reflector is configured to reflect incident waves of light from the light diffuser to the image sensor or camera.

9. The system of claim 1, wherein the stream of fluid is sourced from the sampled pipe and configured to flow from the sampling inlet to the sampling outlet driven by a pressure difference naturally formed by the particle sensor, without using an external device supplying an additional power.

10. The system of claim 1, further comprising a differential pressure sensor between the sampling inlet and the sampling outlet.

11. The system of claim 1, further comprising one or more additional chemical or physical sensors configured to determine one or more parameters of the stream of fluid.

12. The system of claim 1, wherein the light source is an external light source, wherein the light source comprises a laser or LED, and wherein the light source generates a beam of light with a wavelength below 450 nanometers (nm), such as from about 250 nm to about 350 nm.

13. The system of claim 1, wherein the captured image data comprises image data of fluorescence induced or elastic light scattered from at least one particle by the light source.

14. The system of claim 1, wherein the image sensor or camera comprises a color image sensor or camera, such as a color video camera.

15. The system of claim 1, wherein the image data includes a red image data matrix, a green image data matrix, and a blue image data matrix, and wherein the one or more processors is further configured to obtain grayscale image data by at least one of summing or averaging each of the red image data matrix, the green image data matrix, and the blue image data matrix to form an overall image data matrix.

16. The system of claim 1,
wherein the one or more processors is further configured to identify pixels having luminance values that satisfy a threshold, wherein identifying pixels comprises:
determining local thresholds within respective subsets of pixels;
comparing luminance values of pixels within each respective subsets of pixels to respective local threshold for that subset of pixels; and
sweeping through the subsets to pixels to identify the pixels based on the comparison, and
wherein determining particle contours comprises grouping the identified pixels of each of the respective subsets of pixels together as an island of particle contours.

17. The system of claim 16, wherein determining the local thresholds comprises averaging pixel values of the image data within the respective subsets of pixels.

18. The system of claim 16, wherein the one or more processors is further configured to identify adjacent islands of particle contours as belonging to the same particle, and
determining particle contours by fitting the data in the subsets of pixels using a fitting function.

19. The system of claim 18, wherein the fitting function is a Gaussian function.

20. A method of suspended particle detection comprising:
flowing a stream of fluid from a sampling inlet disposed on an inlet arm to a sampling outlet disposed on an outlet arm of a particle sensor;
irradiating at least one particle within the stream of fluid with a focused beam of light from a light source;
capturing, with an image sensor or camera of the particle sensor, image data relating to the at least one particle; and
capturing, in the image data relating to the at least one particle, a monitoring image indicative of an inlet condition of the sampling inlet or inlet arm.
